(19) United States
(12) Patent Application Publication
(10) Pub. No.: US 2023/0106474 A1
(43) Pub. Date: Apr. 6, 2023

(54) DATA-DRIVEN EVALUATION OF TRAINING ACTION SPACE FOR REINFORCEMENT LEARNING

(71) Applicant: NUTANIX, INC., San Jose, CA (US)

(72) Inventors: Rajat GHOSH, San Jose, CA (US); Debojyoti DUTTA, Santa Clara, CA (US); Akshay Anand KHOLE, Fremont, CA (US); Aroosh SOHI, Los Gatos, CA (US)

(21) Appl. No.: 17/858,867

(22) Filed: Jul. 6, 2022

Related U.S. Application Data
(60) Provisional application No. 63/247,989, filed on Sep. 24, 2021.
(60) Provisional application No. 63/262,961, filed on Oct. 23, 2021.

(51) Int. Cl. G06N 20/00

(52) U.S. Cl. CPC G06N 20/00

(57) ABSTRACT

In some embodiments, a method includes receiving a plurality of actions associated with a reinforcement learning model; generating a plurality of combinations of actions based on the plurality of actions; analyzing the plurality of combinations of actions; generating at least one subset of indispensable actions based on the analyzing; selecting a set of training actions from the plurality of actions based on the at least one subset of indispensable actions; and training the reinforcement learning model based on the set of training actions.

### CROSS-REFERENCE TO RELATED APPLICATIONS

This application claims priority from U.S. Provisional Application No. 63/247,989, titled “DATA-DRIVEN ACTION EVALUATION FOR REINFORCEMENT LEARNING,” filed on Sep. 24, 2021, and U.S. Provisional Application No. 63/262,961, titled “DATA-DRIVEN EVALUATION OF TRAINING ACTION SPACE FOR REINFORCEMENT LEARNING,” filed on Oct. 23, 2021, the subject matter of which are incorporated by reference herein in its entirety.

### BACKGROUND

### Field of The Various Embodiments

Embodiments of the present disclosure relate generally to machine learning systems and, more specifically, to data-driven evaluation of a training action space for reinforcement learning.

### Description of The Related Art

Reinforcement learning (RL) is a type of machine learning process in which a software agent maps different situations in an environment to different actions in order to maximize a cumulative reward or minimize a cumulative cost. Reinforcement learning typically involves defining a set of states, a set of actions that can be taken to influence the set of states, and a reward/cost function for determining the reward/cost of transitioning from a first state to a second state due to a given action.

An RL agent is trained to select, for a given state, an action to take from the set of actions to maximize the reward over time. During training, the RL agent explores and evaluates, for a given state, the different actions included in the set of actions to learn a mapping between the different states included in the set of states and the different actions included in the set of actions. However, if the set of actions is too large, then the computational cost of exploring and evaluating all of the actions in the set of actions can be prohibitive. Conversely, if the set of actions is too small, then the trained RL agent could be less effective compared to RL agents trained using a larger set of actions, such as being less able to achieve a desired goal, achieving a lower cumulative reward, and/or requiring a higher cumulative cost compared to the other RL agents.

Accordingly, there is need for improved techniques for selecting a training action set for reinforcement learning.

### SUMMARY

One embodiment sets forth one or more non-transitory computer-readable media storing program instructions that, when executed by one or more processors, cause the one or more processors to perform a method. The method includes receiving a plurality of actions associated with a reinforcement learning model; generating a plurality of combinations of actions based on the plurality of actions; analyzing the plurality of combinations of actions; generating at least one subset of indispensable actions based on the analyzing; selecting a set of training actions from the plurality of actions based on the at least one subset of indispensable actions; and training the reinforcement learning model based on the set of training actions.

Further embodiments provide, among other things, a method and a system for implementing the method described above.

At least one technical advantage of the disclosed techniques relative to the prior art is that, with the disclosed techniques, a reinforcement learning action space can be evaluated to determine which actions should be included within a set of actions used for training and which actions can be excluded without impacting the effectiveness of the trained reinforcement learning agent. As a result, a reinforcement learning agent can be trained using a smaller set of actions while achieving a similar level of effectiveness as a reinforcement learning agent that is trained using a larger set of actions. Thus, with the disclosed techniques, reinforcement learning training is performed faster and utilizes fewer computational resources compared to prior approaches that train a reinforcement learning agent using a larger set of actions or a full set of actions. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram illustrating a system for evaluating a set of actions for a reinforcement learning model, according to various embodiments;

FIG. 2 is a block diagram illustrating data flows for evaluating a set of actions for a reinforcement learning model, according to various embodiments;

FIG. 3 is a flow diagram of method steps for evaluating the action space of a reinforcement learning model, according to various embodiments;

FIG. 4 is a flow diagram of method steps for determining a cut-off cardinality for evaluating an action space of a reinforcement learning model, according to various embodiments;

FIG. 5 is a flow diagram of method steps for evaluating combinations of actions to identify indispensable subsets of actions, according to various embodiments;

FIGS. 6A-6D are block diagrams illustrating virtualization system architectures configured to implement one or more aspects of the present embodiments; and

FIG. 7 is a block diagram illustrating a computer system configured to implement one or more aspects of the present embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Reinforcement learning is a type of machine learning process in which a software agent maps different situations in an environment to different actions in order to maximize a cumulative reward or minimize a cumulative cost. Reinforcement learning typically involves defining a set of states, a set of actions that can be taken to influence the set of states, and a reward function or cost function for determining the reward or cost, respectively, of transitioning from a first state to a second state due to a given action. During training, a reinforcement learning agent explores and evaluates, for a given state, the different actions included in the set of actions to learn a mapping between the different states included in the set of states and the different actions included in the set of actions. Accordingly, when the set of actions is large, the computational cost of exploring and evaluating the set of actions can be prohibitively expensive.

### Reinforcement Learning Action Space Evaluation

To address the computational cost of training a reinforcement learning agent, the set of actions for a reinforcement learning model are evaluated to determine which actions should be used for training and which actions can be excluded without impacting or significantly impacting, the effectiveness (e.g., being less able to achieve a desired goal, achieving a lower cumulative reward, and/or requiring a higher cumulative cost) of the trained reinforcement learning agent. As a result, a subset of the set of actions is identified or selected for use with training the reinforcement learning agent. Because the subset of actions includes fewer actions than the full set of actions, training the reinforcement learning agent using the subset of actions uses fewer computational resources compared to training the reinforcement learning agent using the full set of actions.

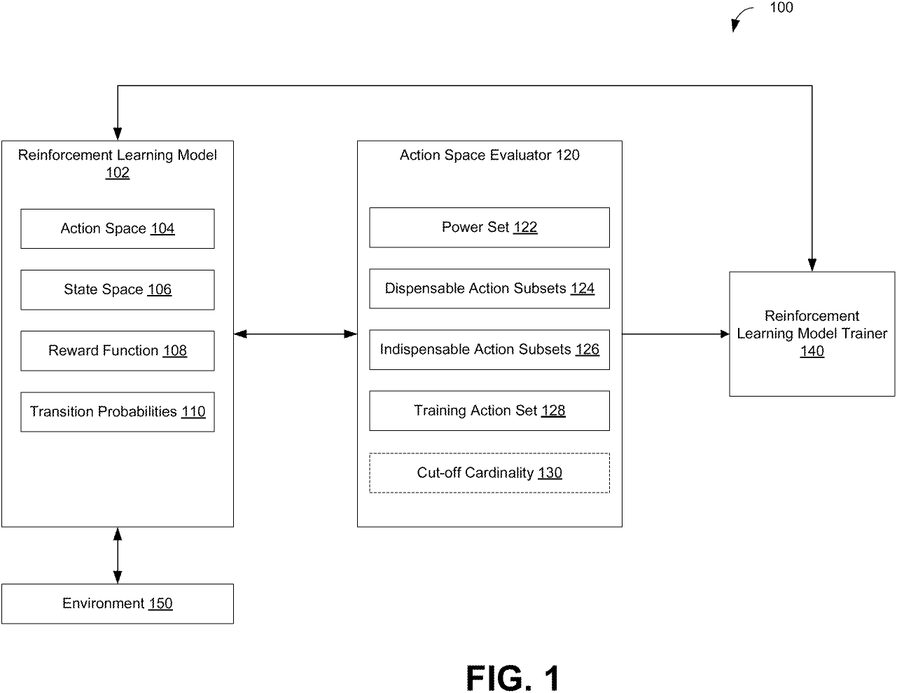

FIG. 1 is a block diagram illustrating a system 100 for evaluating a set of actions for a reinforcement learning model, according to various embodiments. As shown in FIG. 1, system 100 includes, without limitation, a reinforcement learning model 102, an action space evaluator 120, a reinforcement learning model trainer 140, and an environment 150.

Reinforcement learning model 102 corresponds to a reinforcement learning problem that is defined by an action space 104, a state space 106, a reward function 108, and transition probabilities 110. State space 106 includes a set of states for reinforcement learning model 102. Each state included in state space 106 corresponds to a state of an environment associated with the reinforcement learning model 102, such as environment 150.

Action space 104 includes a set of actions that are available to the reinforcement learning model 102 to influence the state of the environment 150. Each action in action space 104 corresponds an action that can be taken within the environment 150 and can cause a change in a current state of the environment. That is, taking a given action within environment 150 transitions the state of the environment 150 from a first state included in state space 106 to a second state included in state space 106.

Transition probabilities 110 represents the probability that the state of the environment 150 will transition from a first state included in state space 106 to a second state included in state space 106 when a given action included in action space 104 is taken.

Environment 150 is an environment in which a reinforcement learning agent of reinforcement learning model 102 executes and/or interacts. During execution, a reinforcement learning agent selects an action from action space 104 and performs the selected action within environment 150 or causes the selected action to be performed within environment 150. The current state of reinforcement learning model 102 is based on the current state of environment 150, and the state that reinforcement learning model 102 transitions to after a selected action is performed is based on the state of environment 150 after the selected action is performed. Accordingly, the transition probabilities 110 of reinforcement learning model 102 are defined based on the properties and dynamics of the environment 150.

In some embodiments, the states included in state space 106 are based on one or more properties of environment 150. The one or more properties can differ depending on the specific environment 150 and the reinforcement learning problem that reinforcement learning model 102 addresses. Additionally, the type of states included in state space 106 (e.q., discrete or continuous) depend on the one or more properties of environment 150 on which the states are based.

As an example, if reinforcement learning model 102 represents a problem of executing tasks within a computing system, the one or more properties of environment 150 could include a number of CPUs, an amount of memory, a current amount of CPU usage, a current amount of memory usage, a number of tasks currently being executed on the computing system, a number of tasks currently assigned to each processor and/or processor group, and/or the like. Each state included in state space 106 corresponds to when the environment 150 has a different number of CPUs, amount of memory, amount of CPU usage, amount of memory usage, number of tasks currently being executed on the computing system, number of tasks assigned to each processor and/or processor group, and/or the like.

In some embodiments, the actions included in action space 104 are based on one or more actions that can be taken in environment 150. The one or more actions can differ depending on the specific environment 150 and the reinforcement learning problem that reinforcement learning model 102 addresses. Referring to the above example, each action included in action space 104 could correspond to assigning a given task to a different processor and/or processor group of the computing system. Other actions could include, for example, determining an amount of resources (e.g., CPU and memory) to allocate to a task, modifying the amount of resources allocated to a task, determining the amount of resources assigned to a processor group, modifying the amount of resources assigned to a processor group, and/or the like.

In some embodiments, the environment 150 is a real environment, such as an actual hardware or software environment. Reinforcement learning model 102 determines a current state based on the actual properties of the real environment. In some embodiments, the environment 150 used for evaluating action space 104 and/or training reinforcement learning model 102 is a simulated or model environment that simulates the state of a hardware or software environment in response to different actions. In some embodiments, the simulated or model environment is a function or other mapping that maps different actions included in action space 104 to different states included in state space 106. A simulated or model environment can be generated using any suitable techniques, such as suing a deep neural network or support vector machine.

Reward function 108 is a function that specifies the reward received (or cost incurred) after transitioning from a first state to a second state due to taking a given action. In some embodiments, reward function 108 is defined based on one or more goals to be achieved by reinforcement learning model 102. A reinforcement learning agent computes a reward (or cost) corresponding to a selected action based on the reward function 108. Additionally, the reinforcement learning agent computes a cumulative reward for a series of actions taken by the reinforcement learning agent by aggregating the reward (or cost) generated by each successive action.

Referring to the previous example, a goal for executing tasks within a computing system, could be reducing task execution time. The reward function 108 could include a component that rewards actions that result in a task execution time below a threshold amount of time, a component that punishes actions that result in a task execution time above a threshold amount of time, and/or a component that provides a reward proportional to the amount of task execution time resulting from the action.

Action space evaluator 120 receives action space 104 and analyzes the actions included in action space 104 to determine which actions should be included when training reinforcement learning model 102. Action space evaluator 120 determines which actions, or subsets of actions, included in action space 104 are indispensable and which actions, or subsets of actions, included in action space 104 are dispensable. An indispensable action or subset of actions is an action or subset of actions that needs to be included when training reinforcement learning model 102 in order for the training to succeed. A dispensable action or subset of actions is an action or subset of actions that does not need to be included when training reinforcement learning model 102, i.e., training can succeed even if the action or subset of actions is not included.

As shown in FIG. 1, action space evaluator 120 generates dispensable action subsets 124 and indispensable action subsets 126 based on the analysis of the actions included in action space 104. Each of the dispensable action subsets 124 includes one or more actions from action space 104 and has been categorized as dispensable. Each of the indispensable action subsets 126 includes one or more actions from action space 104 and has been categorized as indispensable.

In some embodiments, to evaluate action space 104, action space evaluator 120 generates a power set 122. Power set 122 contains different combinations of actions that are included in action space 104. In some embodiments, power set 122 contains all possible combinations of actions that can be generated from the actions included in action space 104. In some embodiments, action space evaluator 120 evaluates all possible combinations of actions that are included in power set 122. In some embodiments, action space evaluator 120 can evaluate fewer than all possible combinations of actions. For example, action space evaluator 120 could evaluate combinations that include more than a certain number of actions (e.g., more than zero, one, two or more actions). Action space evaluator 120 analyzes the different combinations of actions included in power set 122 to determine which actions, or subsets of actions, included in action space 104 are indispensable and which actions, or subsets of actions, included in action space 104 are dispensable.

In some embodiments, to analyze a given combination of actions included in power set 122, action space evaluator 120 uses the combination of actions as an action space for reinforcement learning model 102. Action space evaluator 120 determines whether, when using the combination of actions, reinforcement learning model 102 is able to reach a threshold condition within a given number of steps (i.e., using a given number of selected actions) and starting from a given state. The state can be a pre-determined state, a state specified via user input during execution of action space evaluator 120, a current state of environment 150, a randomly selected state, and/or the like.

In some embodiments, the threshold condition is based on one or more goals associated with the reinforcement learning model 102. For example, the threshold condition could be based on reaching the one or more goals or reaching at least one of the one or more goals. As another example, the threshold condition could be based on satisfying one or more metrics associated with the one or more goals. For example, if a goal is to reduce task execution time, the threshold condition could be reducing task execution time by a first threshold amount, having a task execution time that is below a second threshold amount, and/or the like. The number of steps can be, for example, a pre-configured number, a number specified via user input during execution of action space evaluator 120, a number associated with a given reinforcement learning model 102, a randomly-generated number, and/or the like. Any suitable threshold condition and/or number of steps can be used to evaluate the different combinations of actions.

In some embodiments, action space evaluator 120 determines a threshold condition based on data associated with reinforcement learning model 102. For example, action space evaluator 120 could be configured to evaluate any number or types of reinforcement learning models, and each reinforcement learning model could be associated with data that indicates the specific threshold condition for the reinforcement learning model.

In some embodiments, action space evaluator 120 is configured to evaluate a given reinforcement learning model or a given type of reinforcement learning model. In such embodiments, action space evaluator 120 could be configured to use a specific threshold condition or type of threshold condition. Action space evaluator 120 could be configured to determine specific parameter values associated with the threshold condition. For example, if the threshold condition is based on a given property of environment 150 satisfying a given metric, action space evaluator 120 could be configured to determine the value(s) or range of values of the given property that satisfy the given metric.

In some embodiments, the same threshold condition and number of steps are used when evaluating the action space 104 of a given reinforcement learning model 102. In some embodiments, the same threshold condition and number of steps are used when evaluating the different combinations of actions included in power set 122, but different threshold conditions and/or numbers of steps can be used when evaluating the corresponding reinforcement learning model 102 at different times. That is, at a first time, a first threshold condition and a first number of steps are used to evaluate the action space 104 for a reinforcement learning model 102. At a second time, a second threshold condition and a second number of steps are used to evaluate the action space 104 for the reinforcement learning model 102. The first threshold condition and the second threshold condition and/or the first number of steps and the second number of steps can be different from one another.

For a given combination of actions, if the reinforcement learning model 102 is unable to reach the threshold condition within the given number of steps, then the subset of actions that were not included in the combination of actions is categorized as an indispensable subset of actions. If the reinforcement learning model 102 is able to reach the threshold condition within the given number of steps, then the subset of actions that were not included in the combination of actions is categorized as a dispensable subset of actions. For example, if the action space 104 included actions {A, B, C, D, E} and the combination of actions that is being evaluated included actions {A, B, C}, then the subset of actions not included in the combination of actions would include actions (E, F). If using actions {A, B, C} reinforcement learning model 102 is able to reach a threshold condition within a given number of steps, then the subset of actions {E, F} is categorized as a dispensable subset. Otherwise, if reinforcement learning model 102 is unable to reach the threshold condition within the given number of steps, the subset of actions {E, F} is categorized as an indispensable subset.

In some embodiments, action space evaluator 120 evaluates every combination of actions that is included in power set 122. In some embodiments, action space evaluator 120 selects a subset of the combinations of actions that are included in power set 122 to evaluate. Because action space evaluator 120 does not evaluate every combination of action, action space evaluator 120 can reduce the amount of computational resources and time needed to analyze action space 104.

In some embodiments, action space evaluator 120 determines which combinations of actions to evaluate by determining a cut-off cardinality 130. Cut-off cardinality 130 indicates a threshold cardinality for evaluating the different combinations of actions included in power set 122. If a given combination of actions includes fewer actions than the cut-off cardinality 130 (i.e., has a cardinality below cut-off cardinality 130), then action space evaluator 120 does not evaluate the given combination of actions. After the cut-off cardinality is determined, when evaluating the combinations of actions in power set 122, action space evaluator 120 only evaluates combinations of actions that have a cardinality equal to or greater than the cut-off cardinality 130.

In some embodiments, to determine cut-off cardinality 130, action space evaluator 120 evaluates the different cardinalities of the combinations of actions included in power set 122. For a given cardinality, action space evaluator 120 uses each combination of actions that has the given cardinality as an action space for reinforcement learning model 102. Action space evaluator 120 determines whether, when using the combination of actions, reinforcement learning model 102 is able to reach a threshold condition within a given number of steps (i.e., using a given number of selected actions) and from a given state. The state can be a pre-determined state, a state specified via user input during execution of action space evaluator 120, a current state of environment 150, a randomly selected state, and/or the like.

In some embodiments, the threshold condition and/or the number of steps used for determining cut-off cardinality 130 can be different from the threshold condition and/or the number of steps used for evaluating a combination of actions to identify dispensable and indispensable actions. In some embodiments, the threshold condition when determining a cut-off cardinality 130 is based on improving a cumulative reward by a threshold amount. Action space evaluator 120 determines, for a given combination of actions, whether the cumulative reward generated by the reinforcement learning model 102 improves by the threshold amount within the given number of steps. The number of steps can be, for example, a pre-configured number, a number specified via user input during execution of action space evaluator 120, a number associated with a given reinforcement learning model 102, a randomly-generated number, and/or the like. Similarly, the threshold amount can be a pre-configured amount, an amount specified via user input during execution of action space evaluator 120, an amount associated with a given reinforcement learning model 102, a randomly-generated amount, and/or the like. Any suitable threshold amount and/or number of steps can be used to determine the cut-off cardinality 130. Additionally, the threshold amount can be either a percentage amount (e.g., 1%) or a set amount (e.g., 10). In some embodiments, the threshold amount and/or the number of steps are randomly generated. Additionally, in some embodiments, the random generation is constrained within a specified range of values. For example, the range of values for the threshold amount of improvement can be based on an expected range of reward values (i.e., based on the reward function). As another example, the range of values for the number of steps can be based on a minimum number of steps needed to determine whether the cumulative reward is improving, a maximum number of steps that can be taken within a given amount of computation time, and/or the like.

In some embodiments, action space evaluator 120 determines the highest cardinality at which, when using a combination of actions having that cardinality, reinforcement learning model 102 successfully reaches the threshold condition within the given number of steps. This cardinality is selected as the cut-off cardinality 130.

In some embodiments, action space evaluator 120 selects the highest cardinality from the different cardinalities of the combinations of actions included in power set 122. Action space evaluator 120 uses the combination(s) of actions that has the highest cardinality and determines whether reinforcement learning model 102 reached the threshold condition within the given number of steps using any of the combination(s) of actions. If reinforcement learning model 102 reaches the threshold condition within the given number of steps using at least one combination of actions, then action space evaluator 120 selects the next highest cardinality and evaluates each combination of actions that has the next highest cardinality. The process is repeated until the reinforcement learning model 102 fails to reach the threshold condition within the given number of steps using each combination of actions at a given cardinality. The cardinality that is one higher than the given cardinality is selected as the cut-off cardinality 130. That is, if all combinations of actions having the given cardinality cause the reinforcement learning model 102 to fail to reach the threshold condition within the given number of steps, then action space evaluator 120 selects the previous cardinality (i.e., next higher cardinality) as the cut-off cardinality 130.

In some embodiments, if the reinforcement learning model 102 fails to reach the threshold condition when using the combination of actions having the highest cardinality (e.q., a combination that includes all actions in state space 106), then action space evaluator 120 selects a different threshold condition (e.g., a different threshold amount) and/or a different number of steps and repeats the evaluation using the different threshold condition and/or the different number of steps.

After determining the cut-off cardinality 130, action space evaluator 120 uses the cut-off cardinality 130 to determine which combinations of actions included in power set 122 to evaluate. Action space evaluator 120 evaluates each combination of actions included in power set 122 that has a cardinality equal to or higher than the cut-off cardinality 130 and does not evaluate any combinations of actions that have a cardinality lower than the cut-off cardinality 130.

Action space evaluator 120 generates a training action set 128 based on the dispensable action subsets 124 and/or the indispensable action subsets 126. Training action set 128 includes one or more actions from action space 104. Training action set 128 can include fewer actions than action space 104. In some embodiments, training action set 128 includes at least all of the actions or subsets of actions included in indispensable action subsets 126. Additionally, training action set 128 can include one or more actions or subsets of actions included in dispensable action subsets 124.

In some embodiments, action space evaluator 120 associates each combination of actions with the cumulative reward obtained by the reinforcement learning model 102 using the combination of actions when the combination of actions was previously evaluated. In some embodiments, if reinforcement learning model 102 did not meet the threshold condition within the specified number of steps when using a given combination of actions, then the given combination of actions is not associated with a cumulative reward. Action space evaluator 120 selects the combination of actions with the highest cumulative reward as training action set 128.

In some embodiments, action space evaluator 120 selects the actions or subsets of actions included in indispensable action subsets 126 to include in training action set 128. Additionally, action space evaluator 120 selects one or more actions or subsets of actions from dispensable action subsets 124 to include in training action set 128.

In some embodiments, action space evaluator 120 associates each dispensable action subset included in dispensable action subsets 128 with the cumulative reward obtained by the reinforcement learning model 102 during evaluation of the corresponding combination of actions (i.e., the combination of actions that does not include the dispensable action subset). The cumulative reward associated with a dispensable action subset indicates how well the reinforcement learning model 102 performed when the dispensable action subset was not included. Accordingly, a higher cumulative reward indicates that reinforcement learning model 102 performed well even when the dispensable action subset was not included, while a lower cumulative reward indicates that reinforcement learning model 102 performed less well when the dispensable action subset was not included.

In some embodiments, action space evaluator 120 ranks the dispensable action subsets 128 based on the cumulative reward associated with each dispensable action subset and selects one or more dispensable action subsets associated with the lowest cumulative reward. The number of dispensable action subsets can be, for example, a pre-configured number, a number specified via user input during execution of action space evaluator 120, a number associated with a given reinforcement learning model 102, a randomly-generated number, and/or the like.

In some embodiments, action space evaluator 120 selects one or more dispensable action subsets that are associated with a cumulative reward that is lower than a threshold reward amount. Similarly, the threshold reward amount can be a pre-configured amount, an amount specified via user input during execution of action space evaluator 120, an amount associated with the given reinforcement learning model 102, a randomly-generated amount, and/or the like.

The training action set 128 is provided to a reinforcement learning model trainer 140. Reinforcement learning model trainer 140 uses training action set 128 as the action space for reinforcement learning model 102 when training a reinforcement learning agent, instead of using all of the actions included in action space 104. When training action set 128 includes fewer actions than action space 104, the reinforcement learning training process utilizes fewer computational resources to perform and requires less time to complete. Reinforcement learning model trainer 140 is configured to execute one or more reinforcement learning training algorithms using machine learning model 102 to train a reinforcement learning agent. Any suitable reinforcement learning training algorithm can be used to train a reinforcement learning agent.

In various embodiments, system 100 includes more or fewer components than illustrated in FIG. 1. Although FIG. 1 illustrates action space evaluator 120 as a single component of system 100, in some embodiments, action space evaluator 120 can be multiple modules or applications. For example, a first module or application could be configured to receive action space 104 and compute a cut-off cardinality and a second module or application could be configured to receive action space 104 and generate dispensable action subsets 124 and indispensable action subsets 126. Additionally, a third module or application could be configured to receive dispensable action subsets 124 and indispensable action subsets 126 and generate training action set 128.

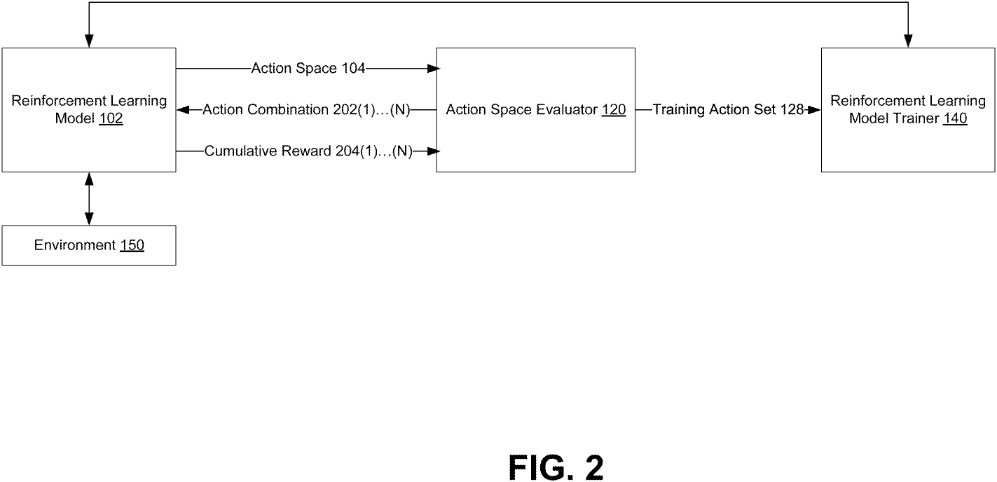

FIG. 2 is a block diagram illustrating data flows for evaluating an action space, such as action space 104, using the action space evaluator 120 of FIG. 1, according to various embodiments. As shown in FIG. 2, action space evaluator 120 receives action space 104 from reinforcement learning model 102. Action space 104 includes a set of actions for interacting with an environment 150.

Action space evaluator 120 generates multiple different combinations of actions, such as action combinations 202(1)-(N), from the set of actions included in action space 104. For example, if action space 104 includes the set of actions {A, B, C, D, E}, action space evaluator 120 generates different combinations of actions, such as {A, B, C, D, E}, {A, B, C, D}, {B, C, D, E}, {A, C, D, E}, {A, B, D, E}, {A, B, C, E}, {A, B, C}, and so on based on the set of actions. As shown in FIG. 2, action space evaluator 120 provides the different action combinations 202 to reinforcement learning model 102 for evaluation.

In some embodiments, action space evaluator 120 provides the different action combinations 202 in order starting from a highest cardinality. Referring to the previous example, action space evaluator 120 first provides the combination {A, B, C, D, E}. Subsequently, action space evaluator 120 provides each one of the combinations {A, B, C, D}, {B, C, D, E}, {A, C, D, E}, {A, B, D, E}, and {A, B, C, E}, and so forth in turn.

In some embodiments, when categorizing action subsets, action space evaluator 120 provides action combinations 202 that have a cardinality equal to or higher than a cut-off cardinality 130. If action space evaluator 120 provides the different action combinations 202 in order starting from the highest cardinality, then action space evaluator 120 stops providing action combinations 202 when the current cardinality determines the cut-off cardinality 130, when determining the cut-off cardinality 130, or when the current cardinality reaches the cut-off cardinality 130, when evaluating the different action combinations 202.

In some embodiments, action space evaluator 120 also provides one or more of a threshold condition, a number of steps, and/or an initial state. For example, if action space evaluator 120 is determining a cut-off cardinality 130, action space evaluator 120 provides the threshold condition and number of steps associated with determining the cut-off cardinality 130. If action space evaluator 120 is categorizing action subsets, then action space evaluator 120 provides the threshold condition and number of steps associated with evaluating the action combinations 202.

Reinforcement learning model 102 receives an action combination 202 and uses the set of actions included in the action combination 202 as the action space for evaluation. In some embodiments, reinforcement learning model 102 also receives a threshold condition and/or a number of steps. Reinforcement learning model 102 performs the reinforcement learning process until the threshold condition is met and/or the number of steps has been performed.

In some embodiments, reinforcement learning model 102 also receives an initial state. Reinforcement learning model 102 begins the reinforcement learning process from the initial state. In some embodiments, reinforcement learning model 102 randomly selects an initial state from state space 106. In some embodiments, reinforcement learning model 102 determines a current state of environment 150 and/or receives information indicating a current state of environment 150. Reinforcement learning model 102 uses the current state of environment 150 as the initial state.

At each step, reinforcement learning model 102 selects an action from the action combination 202, performs the action or causes the action to be performed, and determines the state of environment 150 resulting from the action being performed. Reinforcement learning model 102 computes a reward corresponding to the selected action based on the state of environment 150. Additionally, reinforcement learning model 102 computes a cumulative reward based on the reward corresponding to the selected action and rewards corresponding to any previously selected actions.

After performing the reinforcement learning process for the specified number of steps and/or reaching a threshold condition, reinforcement learning model 102 provides the cumulative reward to action space evaluator 120. As shown in FIG. 2, for each action combination included in action combinations 202(1)-(N), reinforcement learning model 102 generates and provides a corresponding cumulative reward 204(1)-(N).

Additionally, in some embodiments, reinforcement learning model 102 provides additional information (not shown) associated with execution of reinforcement learning model 102 using each action combination 202. For example, reinforcement learning model 102 could provide the state included in state space 106 that corresponds to the current state of environment 150, one or more current property values associated with environment 150, the number of steps performed by reinforcement learning model 102, an amount of reward earned or cost incurred by each step, whether the threshold condition was reached, and/or the like. The additional information can vary depending on the type of evaluation being performed by action space evaluator 120. For example, if action space evaluator 120 is categorizing action subsets, then reinforcement learning model 102 could provide information that indicates whether one or more goals were met.

Action space evaluator 120 receives the cumulative rewards 204 from reinforcement learning model 102. Additionally, in some embodiments, action space evaluator 120 receives the additional information received from reinforcement learning model 102. Action space evaluator 120 performs one or more evaluation operations based on the data received from reinforcement learning model 102 for each action combination 202.

For example, if action space evaluator 120 is computing a cut-off cardinality 130, action space evaluator 120 determines, for a given action combination 202, whether the cumulative reward 204 improved by a threshold amount based on the data received from reinforcement learning model 102. Action space evaluator 120 determines, for a given cardinality, whether the cumulative reward 204 associated with each action combination 202 that had the given cardinality improved by the threshold amount. If none of the cumulative rewards 204 for the action combinations 202 at a given cardinality improved by the threshold amount, then action space evaluator 120 selects the cardinality above the given cardinality as the cut-off cardinality 130. If the cumulative rewards 204 for at least one action combination 202 at the given cardinality improved by the threshold amount, then action space evaluator 120 proceeds to the cardinality below the given cardinality.

As another example, if action space evaluator 120 is evaluating action combinations to categorize action subsets, then action space evaluator 120 determines whether, for a given action combination 202, the threshold condition(s) associated with evaluating action combinations have been met based on the data received from reinforcement learning model 102. If the threshold condition(s) were met, then action space evaluator 120 categorizes the subset of actions that were not included in the given action combination 202 as a dispensable action subset 124. Additionally, in some embodiments, action space evaluator 120 associates the given action combination 202 and/or the dispensable action subset 124 with the corresponding cumulative reward 204. If the threshold condition(s) were not met, then action space evaluator 120 categorizes the subset of actions that were not included in the given action combination 202 as an indispensable action subset 126.

After generating the dispensable action subsets 124 and indispensable action subsets 126, action space evaluator 120 generates a training action set 128 based on the dispensable action subsets 124 and/or the indispensable action subsets 126. In some embodiments, action space evaluator 120 generates the training actions set 128 based on one or more action combinations 202 that are associated with the highest cumulative reward 204. The training action set 128 is used by reinforcement learning model trainer 140 to train reinforcement learning model 102. As shown in FIG. 2, action space evaluator 120 provides the training action set 128 to reinforcement learning model trainer 140.

Reinforcement learning model trainer 140 receives the training action set 128 from action space evaluator 120 and uses the set of actions included in training action set 128 as the action space for reinforcement learning model 102 during the reinforcement learning training process. Reinforcement learning model trainer 140 interacts with reinforcement learning model 102 to train a reinforcement learning agent based on the reinforcement learning model 102 and the training action set 128.

### Exemplary Process Overview

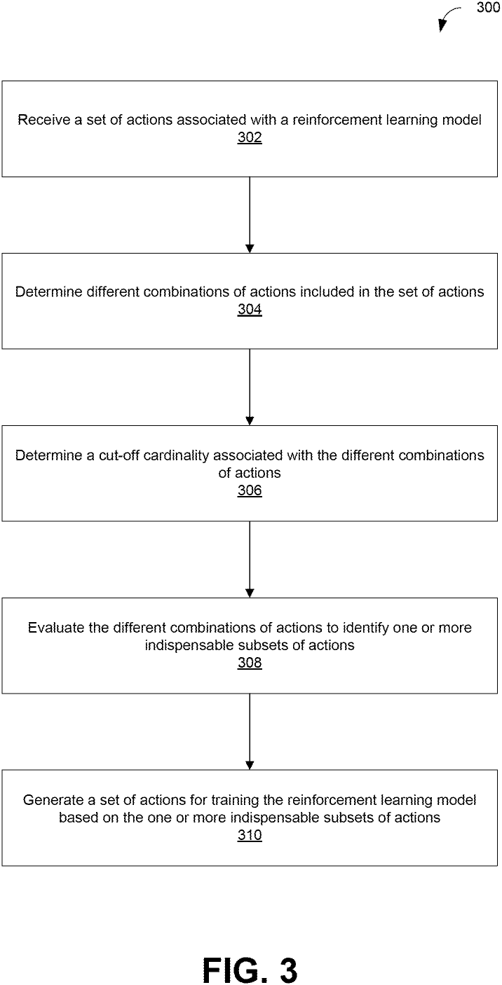

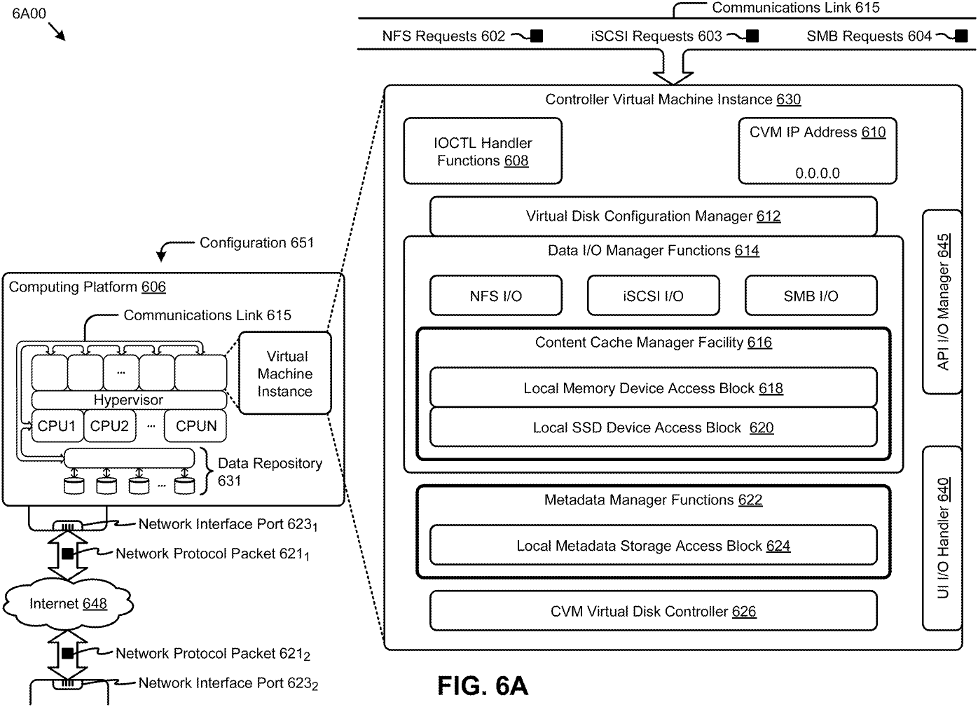

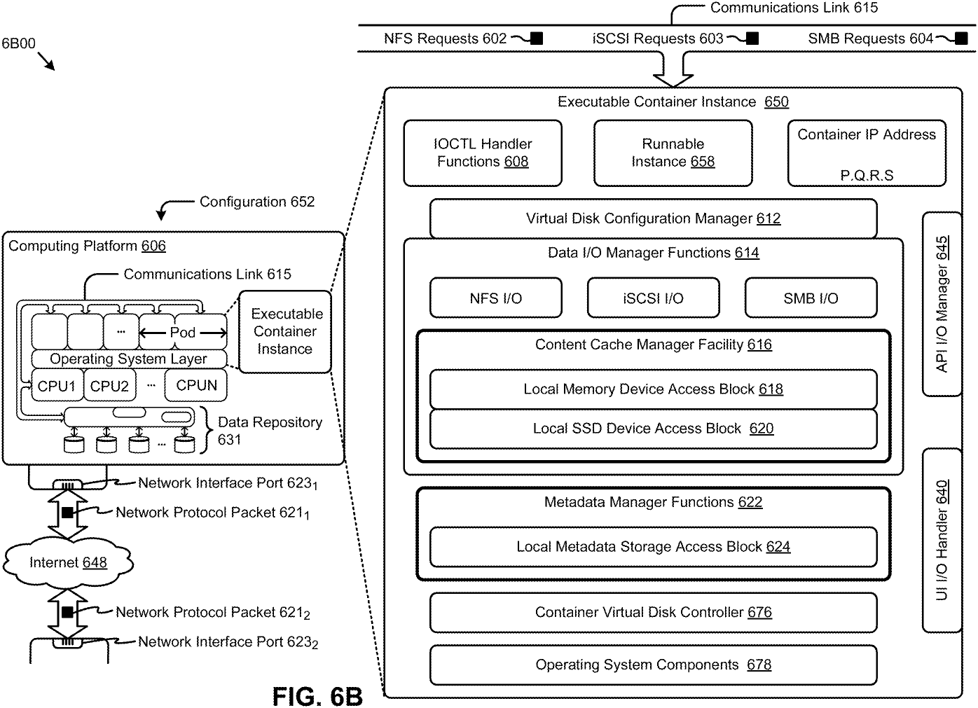

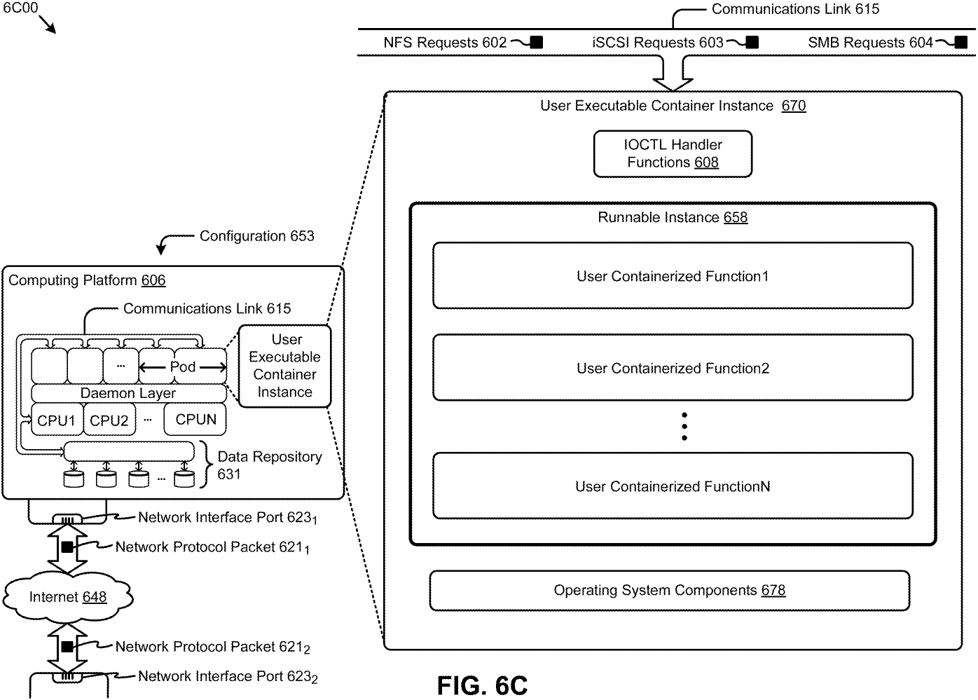

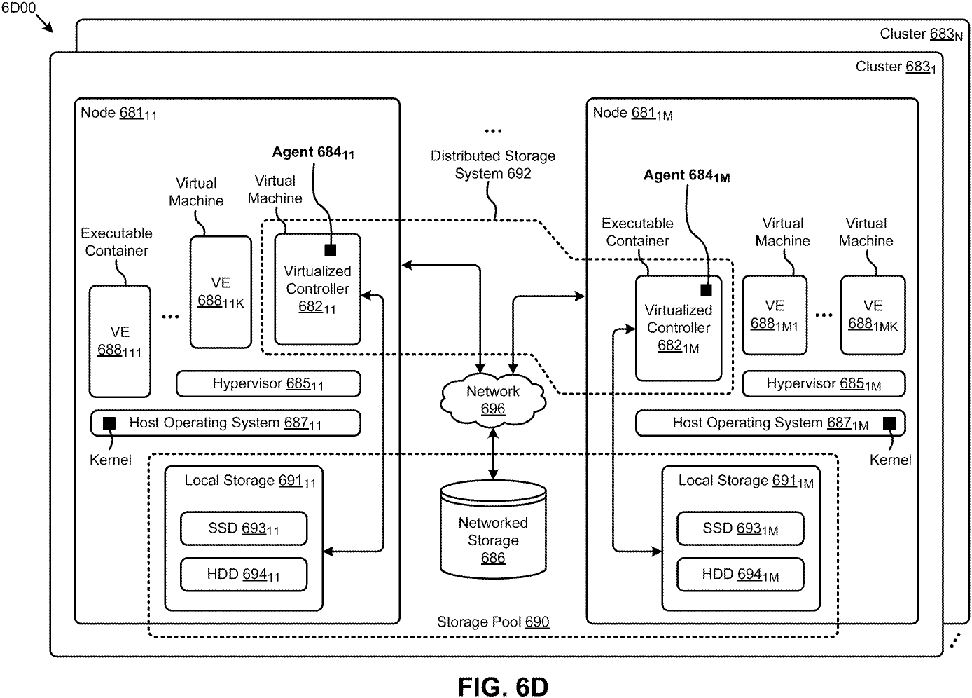

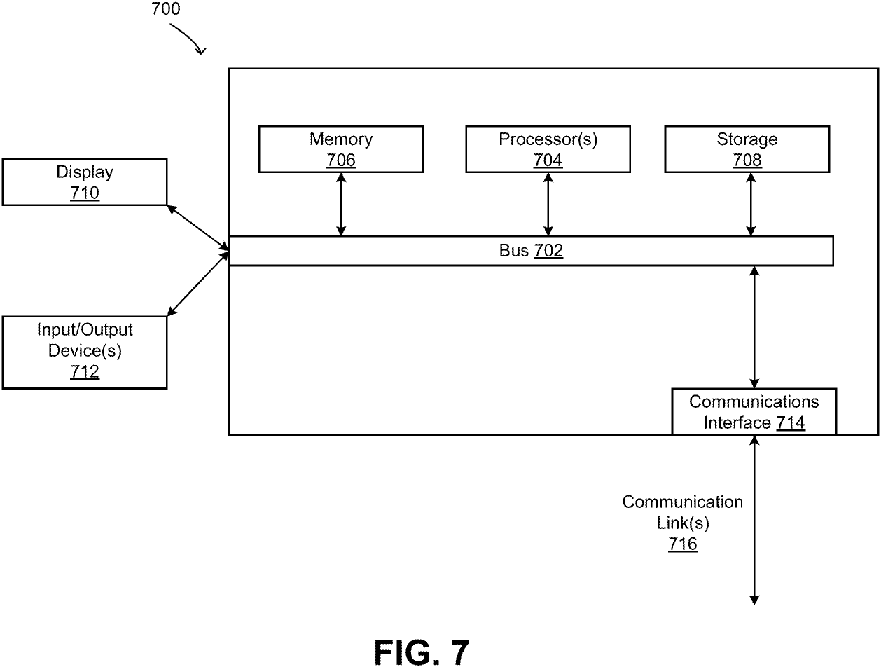

FIG. 3 is a flow diagram of method steps for evaluating the action space of a reinforcement learning model, according to various embodiments. The method steps of FIG. 3 can be performed by any computing device, such as any of the computing systems disclosed in FIG. 6A-7. Furthermore, although the method steps are described with reference to the system of FIGS. 1 and 2, persons skilled in the art will understand that any system configured to implement the method steps, in any order, falls within the scope of the present invention.

As shown in FIG. 3, a method 300 begins at a step 302, where an action space evaluation application receives a set of actions associated with a reinforcement learning model. In some embodiments, the set of actions consists of the actions included in the action space of the reinforcement learning model. For example, action space evaluator 120 receives the set of actions included in action space 104 of reinforcement learning model 102.

At step 304, the action space evaluation application determines different combinations of actions included in the set of actions. Each combination of actions includes one or more actions from the set of actions. For example, action space evaluator 120 generates a power set 122 that contains each of the different combinations of the actions included in action space 104.

In some embodiments, the action space evaluation application determines all possible combinations of actions that can be formed from the set of actions. In some embodiments, the action space evaluation application determines all possible combinations of actions that have more than a threshold number of actions (e.q., more than zero, one, two or more actions).

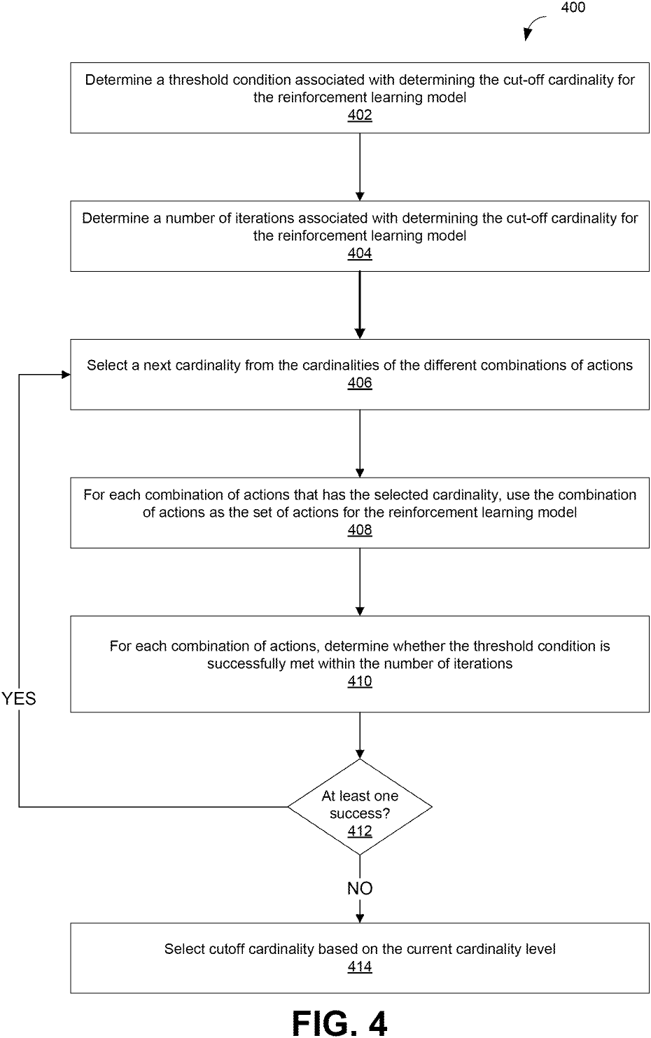

At step 306, the action space evaluation application determines a cut-off cardinality associated with the different combinations of actions. The cut-off cardinality indicates a threshold cardinality for evaluating the different combinations of actions. For example, action space evaluator 120 determines a cut-off cardinality 130 associated with the combinations of actions included in power set 122. Determining a cut-off cardinality is performed in a manner similar to that described above with respect to action space evaluator 120 and cut-off cardinality 130, and in detail below with respect to FIG. 4.

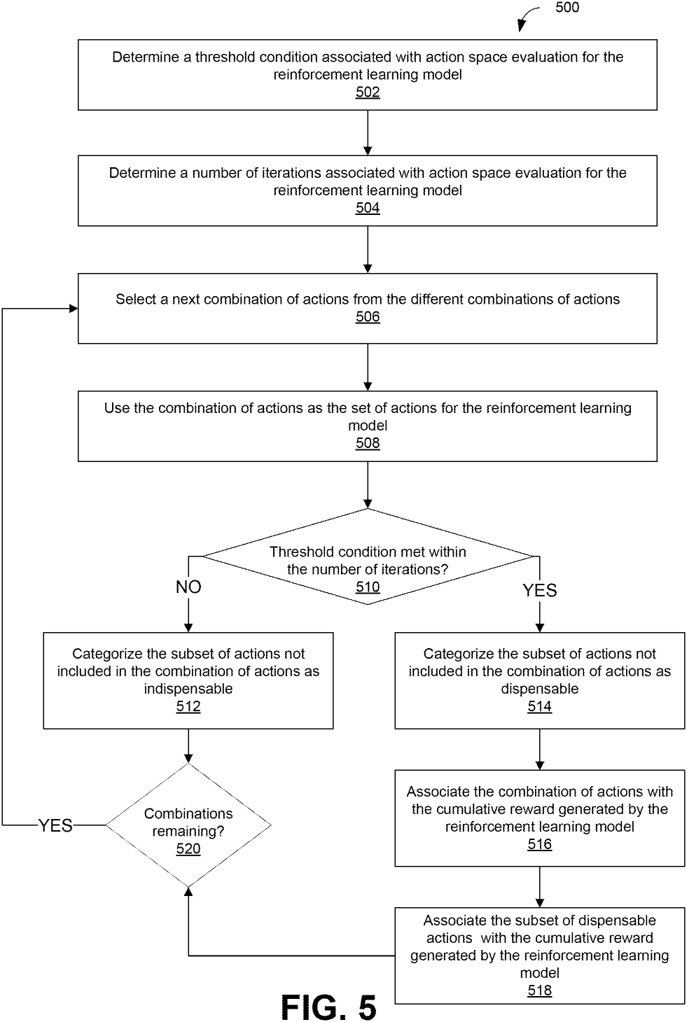

At step 308, the action space evaluation application evaluates the different combinations of actions to identify one or more indispensable subsets of actions. Additionally, in some embodiments, the action space evaluation application identifies one or more dispensable subsets of actions. For example, action space evaluator 120 identifies dispensable action subsets 124 and indispensable action subsets 126. Evaluating the different combinations of actions is performed in a manner similar to that described above with respect to action space evaluator 120, dispensable action subsets 124, and indispensable action subsets 126, and in detail below with respect to FIG. 5. In some embodiments, some or all of the evaluation can be performed currently with the determination of the cut-off cardinality during step 306.

In some embodiments, evaluating the different combinations of actions is based on the cut-off cardinality determined at step 306. The action space evaluation application evaluates only combinations of actions that include the same number of elements or a greater number of elements than the cut-off cardinality. In some embodiments, step 306 above is not performed and a cut-off cardinality is not computed. In such embodiments, each combination of actions included in the different combinations of actions is evaluated, regardless of cardinality.

In some embodiments, evaluating the different combinations of actions is performed at the same time as determining the cut-off cardinality. When a combination of actions is provided to the reinforcement learning model, the threshold condition for determining a cut-off cardinality and the threshold condition for are both evaluated. In such embodiments, the action space evaluation application does not use the cut-off cardinality directly and instead stops evaluating action combinations after the cut-off cardinality has been determined. In some embodiments, if both threshold conditions are evaluated at the same time, the same number of iterations is used for both determining a cut-off cardinality and evaluating the combinations of actions.

In some embodiments, the action space evaluation application associates each combination of actions with a cumulative reward obtained by the reinforcement learning model when using the combination of actions. For example, action space evaluator 120 associates each action combination 202(1)-(N) with the corresponding cumulative reward 204(1)-(N). In some embodiments, the action space evaluation application associates each dispensable subset of actions with the cumulative reward corresponding to the combination of actions that did not include the dispensable subset of actions. For example, action space evaluator 120 associates each dispensable action subset 124 with the cumulative reward 204 corresponding to the action combination 202 that did not include the dispensable action subset 124.

At step 310, the action space evaluation application generates a set of actions for training the reinforcement learning model based on the one or more indispensable subsets of actions. Additionally, in some embodiments, the action space evaluation application generates the set of actions based on one or more dispensable subsets of actions. For example, action space evaluator 120 generates training action set 128 based on indispensable action subsets 126 and dispensable action subsets 124. The set of actions includes one or more actions from the original set of actions. In some embodiments, the set of actions includes at least the one or more indispensable subsets of actions. The set of actions can also include one or more subsets of actions included in the one or more dispensable subsets of actions.

In some embodiments, the action space evaluation application associates each combination of actions with a cumulative reward obtained by the reinforcement learning model when using the combination of actions. For example, action space evaluator 120 associates each action combination 202(1)-(N) with the corresponding cumulative reward 204(1)-(N). The action space evaluation application determines the combination of actions associated with the highest cumulative reward. The action space evaluation application generates a set of actions that includes the actions included in the combination of actions associated with the highest cumulative reward.

In some embodiments, the action space evaluation application selects one or more dispensable subset of actions based on the cumulative reward obtained using the combination of actions associated with each dispensable subset of actions. In some embodiments, action space evaluation application selects a given number (e.g., one, two or more) of dispensable action subsets that are associated with the lowest cumulative reward(s). In some embodiments, action space evaluation application selects each dispensable action subset that is associated with a cumulative reward below a threshold amount.

In some embodiments, the action space evaluation application provides the set of actions to a reinforcement learning model training application. For example, action space evaluator 120 provides training action set 128 to reinforcement learning model trainer 140. Reinforcement learning model trainer 140 uses the training action set 128 as the action space for reinforcement learning model 102 during the training process.

FIG. 4 is a flow diagram of method steps for determining a cut-off cardinality for evaluating an action space of a reinforcement learning model, according to various embodiments. The method steps of FIG. 4 can be performed by any computing device, such as any of the computing systems disclosed in FIG. 6A-7. Furthermore, although the method steps are described with reference to the system of FIGS. 1 and 2, persons skilled in the art will understand that any system configured to implement the method steps, in any order, falls within the scope of the present invention.

As shown in FIG. 4, a method 400 begins at a step 402, where an action space evaluation application determines a threshold condition associated with determining the cut-off cardinality for the reinforcement learning model. For example, action space evaluator 120 determines a threshold condition associated with determining cut-off cardinality 130. In some embodiments, the action space evaluation application selects a threshold condition from a set of threshold conditions. For example, the action space evaluation application identifies a threshold condition associated with the specific reinforcement learning model. As another example, the action space evaluation application randomly selects the threshold condition from the set of threshold conditions.

In some embodiments, the threshold condition associated with determining a cut-off cardinality includes improving the cumulative reward generated by the reinforcement learning model by a threshold amount. The action space evaluation application determines the threshold amount of improvement when determining the threshold condition. The threshold amount can be a percentage or can be a discrete amount. In some embodiments, the threshold amount is a pre-determined or pre-specified amount. For example, a threshold amount could be pre-determined based on the expected rewards generated by reinforcement learning model 102. As another example, a threshold amount could be specified by a user. In some embodiments, the threshold amount is a randomly-generated amount.

At step 404, the action space evaluation application determines a number of iterations associated with determining the cut-off cardinality for the reinforcement learning model. For example, action space evaluator 120 determines a number of iterations associated with determining cut-off cardinality 130. The number of iterations indicates a number of steps taken by the reinforcement learning model in which the threshold condition should be met. For example, if the threshold condition is to improve the cumulative reward generated by the reinforcement learning model by a threshold amount, then to meet the threshold condition, reinforcement learning model has to improve the cumulative reward within the determined number of iterations. In some embodiments, the number of iterations is a pre-determined or pre-specified number. For example, action space evaluator 120 could be configured to use ten iterations when determining a cut-off cardinality. As another example, the number of iterations could be specified by a user. In some embodiments, the number of iterations is a randomly-generated number. In some embodiments, at least one of the threshold amount or the number of iterations is randomly-generated.

At step 406, the action space evaluation application selects a next cardinality from the cardinalities of the different combinations of actions. For example, action space evaluator 120 selects a cardinality for evaluating action combinations 202. In some embodiments, the action space evaluation application selects the highest cardinality that has not been previously selected from the cardinalities of the different combinations of actions. For example, if the set of actions includes five actions, then the cardinalities of the different combinations of actions generated from the set of actions would include cardinalities of five, four, three, two, and one. The action space evaluation application first selects a cardinality of five from the set of cardinalities, and subsequently selects a cardinality of four, and so forth.

At step 408, for each combination of actions that has the selected cardinality, the action space evaluation application uses the combination of actions as the set of actions for the reinforcement learning model. For example, action space evaluator 120 uses each action combination 202 that has the selected cardinality as the action space for reinforcement learning model 102.

The reinforcement learning model executes for up to the number of iterations determined at step 404 above from a given starting state. In some embodiments, the action space evaluation application determines a starting state for the reinforcement learning model. In some embodiments, the starting state for the reinforcement learning model is a current state of an environment associated with the reinforcement learning model, such as environment 150. At each iteration, the reinforcement learning model selects an action from the combination of actions based on a current state of the reinforcement learning model. The reinforcement learning model computes a reward corresponding to each iteration. Additionally, the reinforcement learning model adds the reward corresponding to each iteration to the cumulative reward.

At step 410, the action space evaluation application determines, for each combination of actions that has the selected cardinality, whether the threshold condition was successfully met within the number of iterations when the reinforcement learning model used the combination of actions. For example, action space evaluator 120 determines whether, when using each action combination 202 that has the selected cardinality, reinforcement learning model 102 met the threshold condition after executing for that number of iterations.

In some embodiments, if the threshold condition is improving the cumulative reward obtained by the reinforcement learning model by the threshold amount, the action space evaluation application compares the reward obtained by the reinforcement learning model after the first iteration and the cumulative reward obtained by the reinforcement learning model. The action space evaluation application determines whether the cumulative reward is greater than the reward associated with the first iteration by the threshold amount.

At step 412, the action space evaluation application determines whether any of the combination of actions that has the selected cardinality successfully met the threshold condition within the number of iterations. If at least one combination of actions that has the selected cardinality successfully met the threshold condition within the number of iterations, then the method returns to step 406, where the action space evaluation application selects a next cardinality.

If no combination of actions that has the selected cardinality successfully met the threshold condition within the number of iterations, then the method proceeds to step 414 where the action space evaluation application selects a cut-off cardinality based on the currently selected cardinality. For example, action space evaluator 120 selects a cut-off cardinality 130 based on a currently selected cardinality. In some embodiments, the cut-off cardinality is the cardinality that is one higher than the currently selected cardinality. For example, if the currently selected cardinality is two, then the action space evaluation application selects a cut-off cardinality of three.

FIG. 5 is a flow diagram of method steps for evaluating different combinations of actions to identify one or more indispensable subsets of actions for training a reinforcement learning model, according to various embodiments. The method steps of FIG. 5 can be performed by any computing device, such as any of the computing systems disclosed in FIGS. 6A-7. Furthermore, although the method steps are described with reference to the system of FIGS. 1 and 2, persons skilled in the art will understand that any system configured to implement the method steps, in any order, falls within the scope of the present invention.

As shown in FIG. 5, a method 500 begins at a step 502, where an action space evaluation application determines a threshold condition associated with action space evaluation for the reinforcement learning model. For example, action space evaluator 120 determines a threshold condition associated with evaluating the action space 104 of reinforcement learning model 102. In some embodiments, the threshold condition is based on one or more goals associated with the reinforcement learning model. For example, the threshold condition could be based on reaching the one or more goals and/or reaching one or more metrics associated with the one or more goals.

In some embodiments, the action space evaluation application determines a threshold condition based on data associated with the reinforcement learning model. In some embodiments, the action space evaluation application is configured to use a specific threshold condition or type of threshold condition. Determining the threshold condition could include determining one or more parameter values associated with the threshold condition, such as a target amount for a given metric included in the threshold condition.

At step 504, the action space evaluation application determines a number of iterations associated with action space evaluation for the reinforcement learning model. For example, action space evaluator 120 determines a number of iterations associated with evaluating action space 104. The number of iterations indicates a number of steps taken by the reinforcement learning model in which the threshold condition should be met. For example, if the threshold condition is to have environment 150 reach a given state, then to meet the threshold condition, the actions selected by reinforcement learning model has to cause environment 150 to reach the given state within the determined number of iterations. In some embodiments, the number of iterations is a pre-determined or pre-specified number. For example, action space evaluator 120 could be configured to use ten iterations when evaluating action space 104. As another example, the number of iterations could be specified by a user. In some embodiments, the number of iterations is a randomly-generated number.

At step 506, the action space evaluation application selects a next combination of actions from the different combinations of actions. For example, action space evaluator 120 selects an action combination 202 from power set 122 that has not yet been evaluated. In some embodiments, the action space evaluation application is configured to select combinations of actions in a given order, such as from highest cardinality to lowest cardinality. The action space evaluation application selects the next combination of actions based on the order.

At step 508, the action space evaluation application uses the selected combination of actions as the set of actions for the reinforcement learning model. For example, action space evaluator 120 uses the selected action combination 202 as the action space for reinforcement learning model 102.

The reinforcement learning model executes for the number of iterations determined at step 504 above from a given starting state. In some embodiments, the action space evaluation application determines a starting state for the reinforcement learning model. In some embodiments, the starting state for the reinforcement learning model is a current state of an environment associated with the reinforcement learning model, such as environment 150. At each iteration, the reinforcement learning model selects an action from the combination of actions based on a current state of the reinforcement learning model. The reinforcement learning model computes a reward corresponding to each iteration. Additionally, the reinforcement learning model adds the reward corresponding to each iteration to the cumulative reward.

At step 510, the action space evaluation application determines whether the threshold condition is successfully met within the number of iterations when using the selected combination of actions. For example, action space evaluator 120 determines whether, when using the selected action combination 202, reinforcement learning model 102 met the threshold condition after executing for the number of iterations.

If the threshold condition is not met within the number of iterations, then the method proceeds to step 512. At step 512, the action space evaluation application categorizes the subset of actions that are not included in the combination of actions as indispensable. For example, action space evaluator 120 categorizes the subset of actions that are not included in the selected action combination 202 as an indispensable action subset 126.

If the threshold condition is successfully met within the number of iterations, then the method proceeds to step 514. At step 514, the action space evaluation application categorizes the subset of actions that are not included in the combination of actions as dispensable. For example, action space evaluator 120 categorizes the subset of actions that are not included in the selected action combination 202 as a dispensable action subset 124.

Optionally, at step 516, the action space evaluation application associates the combination of actions with the cumulative reward generated by the reinforcement learning model. For example, action space evaluator 120 associates the selected action combination 202 with the corresponding cumulative reward 204.

Optionally, at step 518, the action space evaluation application associates the subset of dispensable actions with the cumulative reward generated by the reinforcement learning model. For example, action space evaluator 120 associates the subset of actions that are not included in the selected action combination 202 with the cumulative reward 204 corresponding to the selected action combination 202.

As discussed above, the cumulative reward associated with the combination of actions and/or the dispensable action subset are used to determine which dispensable action subsets, if any, should be included in a training action set in addition to one or more indispensable action subsets.

At step 520, if any combinations of actions are remaining, the method returns to step 506, where the action space evaluation application selects the next combination of actions to evaluate. In some embodiments, the above steps are repeated until each combination of actions included in the different combinations of actions have been evaluated. In some embodiments, the steps are repeated until each combination of actions that has a cardinality equal to or greater than the cut-off cardinality have been evaluated.

The approaches described above can be applied to any type of reinforcement learning problem, including managing and/or controlling virtualized, container-based, and/or cloud-based systems. Many aspects of managing such systems can be modeled as reinforcement learning problems. In doing so, a reinforcement learning agent can be trained to perform certain management and/or control tasks for a corresponding system.

For example, one system management problem is deploying virtual machines on a computing cluster, such as a Kubernetes cluster, in a manner that maximizes resource usage and availability of the different virtual machines. In some embodiments, each state included in the state space of the corresponding reinforcement learning problem corresponds to a different set of virtual machine resource utilization metrics of virtual machines deployed in a Kubernetes cluster using various configurations and parameters. Each action included in the action space of the corresponding reinforcement learning problem corresponds to deploying a different virtual machine within the Kubernetes cluster using a different set of parameters and/or a different configuration (e.q., different resource allocations). Accordingly, using the state space and action space of the corresponding reinforcement learning problem, a reinforcement learning agent can be trained to deploy a virtual machine within the Kubernetes cluster based on the current resource utilization of virtual machines already deployed on the Kubernetes cluster.

A second system management problem is predicting Kubernetes node resource exhaustion and scaling the cluster accordingly. In some embodiments, each state included in the state space of the corresponding reinforcement learning problem corresponds to a different resource utilization by nodes within the Kubernetes cluster in various configurations. Each action included in the action space of the corresponding reinforcement learning problem corresponds to a different action that can be performed to scale the cluster, such as, scaling the node pool up, scaling the node pool down, deploying a new node with one or more affinity policies and/or one or more anti-affinity policies, and/or the like. Accordingly, using the state space and action space of the corresponding reinforcement learning problem, a reinforcement agent can be trained to perform a cluster scaling action based on the current resource utilization of the nodes within the Kubernetes cluster.

A third system management problem is efficiently scheduling applications and services to execute within one or more computing clusters, such as Kubernetes clusters. In some embodiments, each state included in the state space of the corresponding reinforcement learning problem corresponds to a different set of component resource consumption metrics indicating the resource consumption of different applications and/or services executing within the multiple Kubernetes clusters. Each action included in the action space of the corresponding reinforcement learning problem corresponds to scheduling a different application or service at a given time and/or on a given Kubernetes cluster. Accordingly, using the state space and action space of the corresponding reinforcement learning problem, a reinforcement learning agent can be trained to deploy an application or service to run on a selected Kubernetes cluster or remove an application or service from a selected Kubernetes cluster based on the current applications and services that are executing within a Kubernetes system.

A fourth system management problem is performance tuning on various microservices deployed on one or more computing clusters, such as Kubernetes clusters. In some embodiments, each state included in the state space of the corresponding reinforcement learning problem corresponds to the request rates and latencies for the different microservices. Each action included in the action space of the corresponding reinforcement learning problem corresponds to performing one or more create, read, update, and delete (CRUD) operations on the different microservices. Accordingly, using the state space and action space of the corresponding reinforcement learning problem, a reinforcement learning agent can be trained to perform performance tuning on the microservices deployed within a Kubernetes system based on the current request rates and latencies of the microservices deployed within the Kubernetes system.

A fifth system management problem is minimizing service mesh pairwise latency within a computing system, such as a Kubernetes system. In some embodiments, each state included in the state space of the corresponding reinforcement learning problem corresponds to a different amount of network traffic occurring within the Kubernetes system, such as between different microservices executing in the Kubernetes system. Each action included in the action space of the corresponding reinforcement learning problem corresponds to a different action that can affect service mesh pairwise latency, such as scaling network traffic up or down, or scaling microservices up or down. Accordingly, using the state space and action space of the corresponding reinforcement learning problem, a reinforcement learning agent can be trained to perform an action that reduces service mesh pairwise latency within a Kubernetes system based on the current network traffic within the Kubernetes system.

As can be seen in the above examples, when modeling a real-world problem as a reinforcement learning problem, the action space for a given reinforcement learning problem can be prohibitively large. Training a reinforcement learning agent using the entirety of the action space would require a significant amount of time and computational resources. Accordingly, using the approaches discussed above to evaluate the action space and determine which subsets of actions are indispensable can greatly reduce the amount of time and computational resources needed to train the reinforcement learning model.

### Exemplary Virtualization System Architectures

According to some embodiments, all or portions of any of the foregoing techniques described with respect to FIGS. 1-5 can be partitioned into one or more modules and instanced within, or as, or in conjunction with a virtualized controller in a virtual computing environment. Some example instances within various virtual computing environments are shown and discussed in further detail in FIGS. 6A-6D. Consistent with these embodiments, a virtualized controller includes a collection of software instructions that serve to abstract details of underlying hardware or software components from one or more higher-level processing entities. In some embodiments, a virtualized controller can be implemented as a virtual machine, as an executable container, or within a layer (e.g., such as a layer in a hypervisor). Consistent with these embodiments, distributed systems include collections of interconnected components that are designed for, or dedicated to, storage operations as well as being designed for, or dedicated to, computing and/or networking operations.

In some embodiments, interconnected components in a distributed system can operate cooperatively to achieve a particular objective such as to provide high-performance computing, high-performance networking capabilities, and/or high-performance storage and/or high-capacity storage capabilities. For example, a first set of components of a distributed computing system can coordinate to efficiently use a set of computational or compute resources, while a second set of components of the same distributed computing system can coordinate to efficiently use the same or a different set of data storage facilities.

In some embodiments, a hyperconverged system coordinates the efficient use of compute and storage resources by and between the components of the distributed system. Adding a hyperconverged unit to a hyperconverged system expands the system in multiple dimensions. As an example, adding a hyperconverged unit to a hyperconverged system can expand the system in the dimension of storage capacity while concurrently expanding the system in the dimension of computing capacity and also in the dimension of networking bandwidth. Components of any of the foregoing distributed systems can comprise physically and/or logically distributed autonomous entities.

In some embodiments, physical and/or logical collections of such autonomous entities can sometimes be referred to as nodes. In some hyperconverged systems, compute and storage resources can be integrated into a unit of a node. Multiple nodes can be interrelated into an array of nodes, which nodes can be grouped into physical groupings (e.g., arrays) and/or into logical groupings or topologies of nodes (e.g., spoke-and-wheel topologies, rings, etc.). Some hyperconverged systems implement certain aspects of virtualization. For example, in a hypervisor-assisted virtualization environment, certain of the autonomous entities of a distributed system can be implemented as virtual machines. As another example, in some virtualization environments, autonomous entities of a distributed system can be implemented as executable containers. In some systems and/or environments, hypervisor-assisted virtualization techniques and operating system virtualization techniques are combined.

FIG. 6A is a block diagram illustrating virtualization system architecture 6A00 configured to implement one or more aspects of the present embodiments. As shown in FIG. 6A, virtualization system architecture 6A00 includes a collection of interconnected components, including a controller virtual machine (CVM) instance 630 in a configuration 651. Configuration 651 includes a computing platform 606 that supports virtual machine instances that are deployed as user virtual machines, or controller virtual machines or both. Such virtual machines interface with a hypervisor (as shown). In some examples, virtual machines may include processing of storage I/O (input/output or IO) as received from any or every source within the computing platform. An example implementation of such a virtual machine that processes storage I/O is depicted as CVM instance 630.

In this and other configurations, a CVM instance receives block I/O storage requests as network file system (NFS) requests in the form of NFS requests 602, internet small computer storage interface (iSCSI) block IO requests in the form of iSCSI requests 603, Samba file system (SMB) requests in the form of SMB requests 604, and/or the like. The CVM instance publishes and responds to an internet protocol (IP) address (e.g., CVM IP address 610). Various forms of input and output can be handled by one or more IO control handler functions (e.g., IOCTL handler functions 608) that interface to other functions such as data IO manager functions 614 and/or metadata manager functions 622. As shown, the data IO manager functions can include communication with virtual disk configuration manager 612 and/or can include direct or indirect communication with any of various block IO functions (e.g., NFS IO, iSCSI IO, SMB IO, etc.).

In addition to block IO functions, configuration 651 supports IO of any form (e.q., block IO, streaming IO, packet-based IO, HTTP traffic, etc.) through either or both of a user interface (UI) handler such as UI IO handler 640 and/or through any of a range of application programming interfaces (APIs), possibly through API IO manager 645.

Communications link 615 can be configured to transmit (e.g., send, receive, signal, etc.) any type of communications packets comprising any organization of data items. The data items can comprise a payload data, a destination address (e.g., a destination IP address) and a source address (e.g., a source IP address), and can include various packet processing techniques (e.g., tunneling), encodings (e.g., encryption), formatting of bit fields into fixed-length blocks or into variable length fields used to populate the payload, and/or the like. In some cases, packet characteristics include a version identifier, a packet or payload length, a traffic class, a flow label, etc. In some cases, the payload comprises a data structure that is encoded and/or formatted to fit into byte or word boundaries of the packet.

In some embodiments, hard-wired circuitry may be used in place of, or in combination with, software instructions to implement aspects of the disclosure. Thus, embodiments of the disclosure are not limited to any specific combination of hardware circuitry and/or software. In embodiments, the term “logic” shall mean any combination of software or hardware that is used to implement all or part of the disclosure.

Computing platform 606 include one or more computer readable media that is capable of providing instructions to a data processor for execution. In some examples, each of the computer readable media may take many forms including, but not limited to, non-volatile media and volatile media. Non-volatile media includes any non-volatile storage medium, for example, solid state storage devices (SSDs) or optical or magnetic disks such as hard disk drives (HDDs) or hybrid disk drives, or random-access persistent memories (RAPMs) or optical or magnetic media drives such as paper tape or magnetic tape drives. Volatile media includes dynamic memory such as random-access memory (RAM). As shown, controller virtual machine instance 630 includes content cache manager facility 616 that accesses storage locations, possibly including local dynamic random-access memory (DRAM) (e.g., through local memory device access block 618) and/or possibly including accesses to local solid-state storage (e.g., through local SSD device access block 620).

Common forms of computer readable media include any non-transitory computer readable medium, for example, floppy disk, flexible disk, hard disk, magnetic tape, or any other magnetic medium; CD-ROM or any other optical medium; punch cards, paper tape, or any other physical medium with patterns of holes; or any RAM, PROM, EPROM, FLASH-EPROM, or any other memory chip or cartridge. Any data can be stored, for example, in any form of data repository 631, which in turn can be formatted into any one or more storage areas, and which can comprise parameterized storage accessible by a key (e.q., a filename, a table name, a block address, an offset address, etc.). Data repository 631 can store any forms of data, and can comprise a storage area dedicated to storage of metadata pertaining to the stored forms of data. In some cases, metadata can be divided into portions. Such portions and/or cache copies can be stored in the storage data repository and/or in a local storage area (e.g., in local DRAM areas and/or in local SSD areas). Such local storage can be accessed using functions provided by local metadata storage access block 624. The data repository 631 can be configured using CVM virtual disk controller 626, which can in turn manage any number or any configuration of virtual disks.

Execution of a sequence of instructions to practice certain of the disclosed embodiments is performed by one or more instances of a software instruction processor, or a processing element such as a data processor, or such as a central processing unit (e.g., CPU₁, CPU₂, ..., CPU_{N}). According to certain embodiments of the disclosure, two or more instances of configuration 651 can be coupled by communications link 615 (e.g., backplane, LAN, PSTN, wired or wireless network, etc.) and each instance may perform respective portions of sequences of instructions as may be required to practice embodiments of the disclosure.

The shown computing platform 606 is interconnected to the Internet 648 through one or more network interface ports (e.g., network interface port 623₁ and network interface port 623₂). Configuration 651 can be addressed through one or more network interface ports using an IP address. Any operational element within computing platform 606 can perform sending and receiving operations using any of a range of network protocols, possibly including network protocols that send and receive packets (e.g., network protocol packet 621₁ and network protocol packet 621₂).

Computing platform 606 may transmit and receive messages that can be composed of configuration data and/or any other forms of data and/or instructions organized into a data structure (e.g., communications packets). In some cases, the data structure includes program instructions (e.g., application code) communicated through the Internet 648 and/or through any one or more instances of communications link 615. Received program instructions may be processed and/or executed by a CPU as it is received and/or program instructions may be stored in any volatile or non-volatile storage for later execution. Program instructions can be transmitted via an upload (e.g., an upload from an access device over the Internet 648 to computing platform 606). Further, program instructions and/or the results of executing program instructions can be delivered to a particular user via a download (e.g., a download from computing platform 606 over the Internet 648 to an access device).

Configuration 651 is merely one example configuration. Other configurations or partitions can include further data processors, and/or multiple communications interfaces, and/or multiple storage devices, etc. within a partition. For example, a partition can bound a multi-core processor (e.g., possibly including embedded or collocated memory), or a partition can bound a computing cluster having a plurality of computing elements, any of which computing elements are connected directly or indirectly to a communications link. A first partition can be configured to communicate to a second partition. A particular first partition and a particular second partition can be congruent (e.g., in a processing element array) or can be different (e.g., comprising disjoint sets of components).

A cluster is often embodied as a collection of computing nodes that can communicate between each other through a local area network (e.g., LAN or virtual LAN (VLAN)) or a backplane. Some clusters are characterized by assignment of a particular set of the aforementioned computing nodes to access a shared storage facility that is also configured to communicate over the local area network or backplane. In many cases, the physical bounds of a cluster are defined by a mechanical structure such as a cabinet or such as a chassis or rack that hosts a finite number of mounted-in computing units. A computing unit in a rack can take on a role as a server, or as a storage unit, or as a networking unit, or any combination therefrom. In some cases, a unit in a rack is dedicated to provisioning of power to other units. In some cases, a unit in a rack is dedicated to environmental conditioning functions such as filtering and movement of air through the rack and/or temperature control for the rack. Racks can be combined to form larger clusters. For example, the LAN of a first rack having a quantity of 32 computing nodes can be interfaced with the LAN of a second rack having 16 nodes to form a two-rack cluster of 48 nodes. The former two LANs can be configured as subnets, or can be configured as one VLAN. Multiple clusters can communicate between one module to another over a WAN (e.g., when geographically distal) or a LAN (e.g., when geographically proximal).

In some embodiments, a module can be implemented using any mix of any portions of memory and any extent of hard-wired circuitry including hard-wired circuitry embodied as a data processor. Some embodiments of a module include one or more special-purpose hardware components (e.g., power control, logic, sensors, transducers, etc.). A data processor can be organized to execute a processing entity that is configured to execute as a single process or configured to execute using multiple concurrent processes to perform work. A processing entity can be hardware-based (e.q., involving one or more cores) or software-based, and/or can be formed using a combination of hardware and software that implements logic, and/or can carry out computations and/or processing steps using one or more processes and/or one or more tasks and/or one or more threads or any combination thereof.

Some embodiments of a module include instructions that are stored in a memory for execution so as to facilitate operational and/or performance characteristics pertaining to management of block stores. Various implementations of the data repository comprise storage media organized to hold a series of records and/or data structures.

Further details regarding general approaches to managing data repositories are described in U.S. Pat. No. 8,601,473 titled “ARCHITECTURE FOR MANAGING I/O AND STORAGE FOR A VIRTUALIZATION ENVIRONMENT”, issued on Dec. 3, 2013, which is hereby incorporated by reference in its entirety.

Further details regarding general approaches to managing and maintaining data in data repositories are described in U.S. Pat. No. 8,549,518 titled “METHOD AND SYSTEM FOR IMPLEMENTING A MAINTENANCE SERVICE FOR MANAGING I/O AND STORAGE FOR A VIRTUALIZATION ENVIRONMENT”, issued on Oct. 1, 2013, which is hereby incorporated by reference in its entirety.

FIG. 6B depicts a block diagram illustrating another virtualization system architecture 6B00 configured to implement one or more aspects of the present embodiments. As shown in FIG. 6B, virtualization system architecture 6B00 includes a collection of interconnected components, including an executable container instance 650 in a configuration 652. Configuration 652 includes a computing platform 606 that supports an operating system layer (as shown) that performs addressing functions such as providing access to external requestors (e.g., user virtual machines or other processes) via an IP address (e.g., “P.Q.R.S”, as shown). Providing access to external requestors can include implementing all or portions of a protocol specification (e.g., “http:”) and possibly handling port-specific functions. In some embodiments, external requestors (e.g., user virtual machines or other processes) rely on the aforementioned addressing functions to access a virtualized controller for performing all data storage functions. Furthermore, when data input or output requests are received from a requestor running on a first node are received at the virtualized controller on that first node, then in the event that the requested data is located on a second node, the virtualized controller on the first node accesses the requested data by forwarding the request to the virtualized controller running at the second node. In some cases, a particular input or output request might be forwarded again (e.g., an additional or Nth time) to further nodes. As such, when responding to an input or output request, a first virtualized controller on the first node might communicate with a second virtualized controller on the second node, which second node has access to particular storage devices on the second node or, the virtualized controller on the first node may communicate directly with storage devices on the second node.

The operating system layer can perform port forwarding to any executable container (e.g., executable container instance 650). An executable container instance can be executed by a processor. Runnable portions of an executable container instance sometimes derive from an executable container image, which in turn might include all, or portions of any of, a Java archive repository (JAR) and/or its contents, and/or a script or scripts and/or a directory of scripts, and/or a virtual machine configuration, and may include any dependencies therefrom. In some cases, a configuration within an executable container might include an image comprising a minimum set of runnable code. Contents of larger libraries and/or code or data that would not be accessed during runtime of the executable container instance can be omitted from the larger library to form a smaller library composed of only the code or data that would be accessed during runtime of the executable container instance. In some cases, start-up time for an executable container instance can be much faster than start-up time for a virtual machine instance, at least inasmuch as the executable container image might be much smaller than a respective virtual machine instance. Furthermore, start-up time for an executable container instance can be much faster than start-up time for a virtual machine instance, at least inasmuch as the executable container image might have many fewer code and/or data initialization steps to perform than a respective virtual machine instance.

An executable container instance can serve as an instance of an application container or as a controller executable container. Any executable container of any sort can be rooted in a directory system and can be configured to be accessed by file system commands (e.g., “Is” or “Is -a”, etc.). The executable container might optionally include operating system components 678, however such a separate set of operating system components need not be provided. As an alternative, an executable container can include runnable instance 658, which is built (e.g., through compilation and linking, or just-in-time compilation, etc.) to include all of the library and OS-like functions needed for execution of the runnable instance. In some cases, a runnable instance can be built with a virtual disk configuration manager, any of a variety of data IO management functions, etc. In some cases, a runnable instance includes code for, and access to, container virtual disk controller 676. Such a container virtual disk controller can perform any of the functions that the aforementioned CVM virtual disk controller 626 can perform, yet such a container virtual disk controller does not rely on a hypervisor or any particular operating system so as to perform its range of functions.

In some environments, multiple executable containers can be collocated and/or can share one or more contexts. For example, multiple executable containers that share access to a virtual disk can be assembled into a pod (e.g., a Kubernetes pod). Pods provide sharing mechanisms (e.g., when multiple executable containers are amalgamated into the scope of a pod) as well as isolation mechanisms (e.g., such that the namespace scope of one pod does not share the namespace scope of another pod).

FIG. 6C is a block diagram illustrating virtualization system architecture 6C00 configured to implement one or more aspects of the present embodiments. As shown in FIG. 6C, virtualization system architecture 6C00 includes a collection of interconnected components, including a user executable container instance in configuration 653 that is further described as pertaining to user executable container instance 670. Configuration 653 includes a daemon layer (as shown) that performs certain functions of an operating system.

User executable container instance 670 comprises any number of user containerized functions (e.g., user containerized function₁, user containerized function₂, ..., user containerized function_{N}). Such user containerized functions can execute autonomously or can be interfaced with or wrapped in a runnable object to create a runnable instance (e.q., runnable instance 658). In some cases, the shown operating system components 678 comprise portions of an operating system, which portions are interfaced with or included in the runnable instance and/or any user containerized functions. In some embodiments of a daemon-assisted containerized architecture, computing platform 606 might or might not host operating system components other than operating system components 678. More specifically, the shown daemon might or might not host operating system components other than operating system components 678 of user executable container instance 670.

In some embodiments, the virtualization system architecture 6A00, 6B00, and/or 6C00 can be used in any combination to implement a distributed platform that contains multiple servers and/or nodes that manage multiple tiers of storage where the tiers of storage might be formed using the shown data repository 631 and/or any forms of network accessible storage. As such, the multiple tiers of storage may include storage that is accessible over communications link 615. Such network accessible storage may include cloud storage or networked storage (e.g., a SAN or storage area network). Unlike prior approaches, the disclosed embodiments permit local storage that is within or directly attached to the server or node to be managed as part of a storage pool. Such local storage can include any combinations of the aforementioned SSDs and/or HDDs and/or RAPMs and/or hybrid disk drives. The address spaces of a plurality of storage devices, including both local storage (e.g., using node-internal storage devices) and any forms of network-accessible storage, are collected to form a storage pool having a contiguous address space.

Significant performance advantages can be gained by allowing the virtualization system to access and utilize local (e.g., node-internal) storage. This is because I/O performance is typically much faster when performing access to local storage as compared to performing access to networked storage or cloud storage. This faster performance for locally attached storage can be increased even further by using certain types of optimized local storage devices such as SSDs or RAPMs, or hybrid HDDs, or other types of high-performance storage devices.

In some embodiments, each storage controller exports one or more block devices or NFS or iSCSI targets that appear as disks to user virtual machines or user executable containers. These disks are virtual since they are implemented by the software running inside the storage controllers. Thus, to the user virtual machines or user executable containers, the storage controllers appear to be exporting a clustered storage appliance that contains some disks. User data (including operating system components) in the user virtual machines resides on these virtual disks.

In some embodiments, any one or more of the aforementioned virtual disks can be structured from any one or more of the storage devices in the storage pool. In some embodiments, a virtual disk is a storage abstraction that is exposed by a controller virtual machine or container to be used by another virtual machine or container. In some embodiments, the virtual disk is exposed by operation of a storage protocol such as iSCSI or NFS or SMB. In some embodiments, a virtual disk is mountable. In some embodiments, a virtual disk is mounted as a virtual storage device.

In some embodiments, some or all of the servers or nodes run virtualization software. Such virtualization software might include a hypervisor (e.g., as shown in configuration 651) to manage the interactions between the underlying hardware and user virtual machines or containers that run client software.

Distinct from user virtual machines or user executable containers, a special controller virtual machine (e.g., as depicted by controller virtual machine instance 630) or as a special controller executable container is used to manage certain storage and I/O activities. Such a special controller virtual machine is sometimes referred to as a controller executable container, a service virtual machine (SVM), a service executable container, or a storage controller. In some embodiments, multiple storage controllers are hosted by multiple nodes. Such storage controllers coordinate within a computing system to form a computing cluster.

The storage controllers are not formed as part of specific implementations of hypervisors. Instead, the storage controllers run above hypervisors on the various nodes and work together to form a distributed system that manages all of the storage resources, including the locally attached storage, the networked storage, and the cloud storage. In example embodiments, the storage controllers run as special virtual machines—above the hypervisors—thus, the approach of using such special virtual machines can be used and implemented within any virtual machine architecture. Furthermore, the storage controllers can be used in conjunction with any hypervisor from any virtualization vendor and/or implemented using any combinations or variations of the aforementioned executable containers in conjunction with any host operating system components.

FIG. 6D is a block diagram illustrating virtualization system architecture 6D00 configured to implement one or more aspects of the present embodiments. As shown in FIG. 6D, virtualization system architecture 6D00 includes a distributed virtualization system that includes multiple clusters (e.g., cluster 683₁, ..., cluster 683_{N}) comprising multiple nodes that have multiple tiers of storage in a storage pool. Representative nodes (e.g., node 681₁₁, ..., node 681_{1M}) and storage pool 690 associated with cluster 683₁ are shown. Each node can be associated with one server, multiple servers, or portions of a server. The nodes can be associated (e.g., logically and/or physically) with the clusters. As shown, the multiple tiers of storage include storage that is accessible through a network 696, such as a networked storage 686 (e.g., a storage area network or SAN, network attached storage or NAS, etc.). The multiple tiers of storage further include instances of local storage (e.g., local storage 691₁₁, ..., local storage 691_{1M}). For example, the local storage can be within or directly attached to a server and/or appliance associated with the nodes. Such local storage can include solid state drives (SSD 693₁₁, ..., SSD 693_{1M}), hard disk drives (HDD 694₁₁, ..., HDD 694_{1M}), and/or other storage devices.

As shown, any of the nodes of the distributed virtualization system can implement one or more user virtualized entities (e.g., VE 688₁₁₁, ..., VE 688_{11K}, ..., VE 688_{1M1}, ..., VE 688_{1MK}), such as virtual machines (VMs) and/or executable containers. The VMs can be characterized as software-based computing “machines” implemented in a container-based or hypervisor-assisted virtualization environment that emulates the underlying hardware resources (e.g., CPU, memory, etc.) of the nodes. For example, multiple VMs can operate on one physical machine (e.g., node host computer) running a single host operating system (e.q., host operating system 687₁₁, ..., host operating system 687_{1M}), while the VMs run multiple applications on various respective guest operating systems. Such flexibility can be facilitated at least in part by a hypervisor (e.g., hypervisor 685₁₁, ..., hypervisor 685_{1M}), which hypervisor is logically located between the various guest operating systems of the VMs and the host operating system of the physical infrastructure (e.q., node).

As an alternative, executable containers may be implemented at the nodes in an operating system-based virtualization environment or in a containerized virtualization environment. The executable containers are implemented at the nodes in an operating system virtualization environment or container virtualization environment. The executable containers can include groups of processes and/or resources (e.g., memory, CPU, disk, etc.) that are isolated from the node host computer and other containers. Such executable containers directly interface with the kernel of the host operating system (e.g., host operating system 687₁₁, ..., host operating system 687_{1M}) without, in most cases, a hypervisor layer. This lightweight implementation can facilitate efficient distribution of certain software components, such as applications or services (e.g., micro-services). Any node of a distributed virtualization system can implement both a hypervisor-assisted virtualization environment and a container virtualization environment for various purposes. Also, any node of a distributed virtualization system can implement any one or more types of the foregoing virtualized controllers so as to facilitate access to storage pool 690 by the VMs and/or the executable containers.

Multiple instances of such virtualized controllers can coordinate within a cluster to form the distributed storage system 692 which can, among other operations, manage the storage pool 690. This architecture further facilitates efficient scaling in multiple dimensions (e.g., in a dimension of computing power, in a dimension of storage space, in a dimension of network bandwidth, etc.).

In some embodiments, a particularly-configured instance of a virtual machine at a given node can be used as a virtualized controller in a hypervisor-assisted virtualization environment to manage storage and I/O (input/output or IO) activities of any number or form of virtualized entities. For example, the virtualized entities at node 681₁₁ can interface with a controller virtual machine (e.g., virtualized controller 682₁₁) through hypervisor 685₁₁ to access data of storage pool 690. In such cases, the controller virtual machine is not formed as part of specific implementations of a given hypervisor. Instead, the controller virtual machine can run as a virtual machine above the hypervisor at the various node host computers. When the controller virtual machines run above the hypervisors, varying virtual machine architectures and/or hypervisors can operate with the distributed storage system 692. For example, a hypervisor at one node in the distributed storage system 692 might correspond to software from a first vendor, and a hypervisor at another node in the distributed storage system 692 might correspond to a second software vendor. As another virtualized controller implementation example, executable containers can be used to implement a virtualized controller (e.g., virtualized controller 682_{1M}) in an operating system virtualization environment at a given node. In this case, for example, the virtualized entities at node 681_{1M} can access the storage pool 690 by interfacing with a controller container (e.g., virtualized controller 682_{1M}) through hypervisor 685_{1M} and/or the kernel of host operating system 687_{1M}.

In some embodiments, one or more instances of an agent can be implemented in the distributed storage system 692 to facilitate the herein disclosed techniques. Specifically, agent 684₁₁ can be implemented in the virtualized controller 682₁₁, and agent 684_{1M} can be implemented in the virtualized controller 682_{1M}. Such instances of the virtualized controller can be implemented in any node in any cluster. Actions taken by one or more instances of the virtualized controller can apply to a node (or between nodes), and/or to a cluster (or between clusters), and/or between any resources or subsystems accessible by the virtualized controller or their agents.

### Exemplary Computer System

FIG. 7 is a block diagram illustrating a computer system 700 configured to implement one or more aspects of the present embodiments. In some embodiments, computer system 700 may be representative of a computer system for implementing one or more aspects of the embodiments disclosed in FIGS. 1-5. In some embodiments, computer system 700 is a server machine operating in a data center or a cloud computing environment suitable for implementing an embodiment of the present invention. As shown, computer system 700 includes a bus 702 or other communication mechanism for communicating information, which interconnects subsystems and devices, such as one or more processors 704, memory 706, storage 708, optional display 710, one or more input/output devices 712, and a communications interface 714. Computer system 700 described herein is illustrative and any other technically feasible configurations fall within the scope of the present disclosure.

The one or more processors 704 include any suitable processors implemented as a central processing unit (CPU), a graphics processing unit (GPU), an application-specific integrated circuit (ASIC), a field programmable gate array (FPGA), an artificial intelligence (Al) accelerator, any other type of processor, or a combination of different processors, such as a CPU configured to operate in conjunction with a GPU. In general, the one or more processors 704 may be any technically feasible hardware unit capable of processing data and/or executing software applications. Further, in the context of this disclosure, the computing elements shown in computer system 700 may correspond to a physical computing system (e.q., a system in a data center) or may be a virtual computing instance, such as any of the virtual machines described in FIGS. 6A-6D.

Memory 706 includes a random-access memory (RAM) module, a flash memory unit, and/or any other type of memory unit or combination thereof. The one or more processors 704, and/or communications interface 714 are configured to read data from and write data to memory 706. Memory 706 includes various software programs that include one or more instructions that can be executed by the one or more processors 704 and application data associated with said software programs.

Storage 708 includes non-volatile storage for applications and data, and may include one or more fixed or removable disk drives, HDDs, SSD, NVMes, vDisks, flash memory devices, and/or other magnetic, optical, and/or solid-state storage devices.

Communications interface 714 includes hardware and/or software for coupling computer system 700 to one or more communication links 716. The one or more communication links 716 may include any technically feasible type of communications network that allows data to be exchanged between computer system 700 and external entities or devices, such as a web server or another networked computing system. For example, the one or more communication links 716 may include one or more wide area networks (WANs), one or more local area networks (LANs), one or more wireless (WiFi) networks, the Internet, and/or the like.

In sum, a set of actions in the action space for a reinforcement learning model are evaluated to determine which actions should be used when training the reinforcement learning model. Different combinations of actions are generated based on the set of actions included in the action space. Each combination of actions is provided to the reinforcement learning model. The reinforcement learning model attempts to reach a threshold condition from a given starting state within a given number of steps. If, using a given combination of actions, the reinforcement learning model is unable to reach the threshold condition within the given number of steps, then the subset of actions in the action space that were not included in the given combination is categorized as an indispensable subset. If, using the given combination of actions, the reinforcement learning model is able to reach the threshold condition within the given number of steps, then the subset of actions that were not included in the given combination is categorized as a dispensable subset. After the different combinations of actions have been evaluated, the subsets of actions that are categorized as indispensable are included in the set of training actions used in the training a reinforcement learning agent for the reinforcement learning model.

In some approaches, a cutoff cardinality is determined for testing the different combinations of actions. Each combination of actions is provided to the reinforcement learning model. The reinforcement learning model attempts to improve the cumulative reward by a threshold amount within a given number of steps from a given starting state. If the reinforcement learning model fails to improve the cumulative reward by the threshold amount using every combination of actions at given cardinality, then the cardinality that is one higher than the given cardinality is used as the cut-off cardinality. When evaluating the different combinations actions to identify indispensable action subsets, if a combination of actions includes a number of actions fewer than the cut-off cardinality, then the combination of actions is not evaluated.

In some approaches, if the reinforcement learning model is able to reach the desired goal from the starting state within the threshold number of steps using a given combination of actions, the given combination of actions is associated with the cumulative reward that was generated by the reinforcement learning model. The cumulative rewards associated with different combinations of actions are used to determine which dispensable actions and/or subsets of actions should also be included in the action space used for reinforcement learning training.

At least one technical advantage of the disclosed techniques relative to the prior art is that, with the disclosed techniques, a reinforcement learning action space can be evaluated to determine which actions should be included within a set of actions used for training and which actions can be excluded without impacting the effectiveness of the trained reinforcement learning agent. As a result, a reinforcement learning agent can be trained using a smaller set of actions while achieving a similar level of effectiveness as a reinforcement learning agent that is trained using a larger set of actions. Thus, with the disclosed techniques, reinforcement learning training is performed faster and utilizes fewer computational resources compared to prior approaches that train a reinforcement learning agent using a larger set of actions or a full set of actions. These technical advantages provide one or more technological improvements over prior art approaches.

1. In some embodiments, one or more non-transitory computer-readable media store program instructions that, when executed by one or more processors, cause the one or more processors to perform a method comprising receiving a plurality of actions associated with a reinforcement learning model; generating a plurality of combinations of actions based on the plurality of actions; analyzing the plurality of combinations of actions; generating at least one subset of indispensable actions based on the analyzing; selecting a set of training actions from the plurality of actions based on the at least one subset of indispensable actions; and training the reinforcement learning model based on the set of training actions.

2. The one or more non-transitory computer-readable media of clause 1, wherein selecting the set of training actions is further based on one or more cumulative rewards associated with the plurality of combinations of actions.

3. The one or more non-transitory computer-readable media of clause 1 or clause 2, wherein analyzing the plurality of combinations of actions comprises causing the reinforcement learning model to execute a first number of iterations using a first combination of actions to determine whether the reinforcement learning model satisfies a first threshold condition after the first number of iterations using the first combination of actions.

4. The one or more non-transitory computer-readable media of any of clauses 1-3, wherein generating the at least one subset of indispensable actions is based on determining that the reinforcement learning model does not satisfy the first threshold condition after the first number of iterations using the first combination of actions.

5. The one or more non-transitory computer-readable media of any of clauses 1-4, wherein generating the at least one subset of indispensable actions comprises generating a first subset of indispensable actions based on analyzing a first combination of actions that does not include the first subset of indispensable actions.

6. The one or more non-transitory computer-readable media of any of clauses 1-5, wherein analyzing the plurality of combinations of actions comprises computing a cut-off cardinality associated with the plurality of combinations of actions.

7. The one or more non-transitory computer-readable media of any of clauses 1-6, wherein computing the cut-off cardinality comprises evaluating combinations of actions having a given cardinality to determine whether each of the combinations of actions having the given cardinality fail to improve a cumulative reward by a threshold amount.

8. The one or more non-transitory computer-readable media of any of clauses 1-7, wherein the reinforcement learning model is associated with managing one or more components of a computing system, wherein each state included in a plurality of states associated with the reinforcement learning model corresponds to a different set of resource utilization metrics associated with the computing system, and wherein each action included in the plurality of actions corresponds to a different component management action associated with a different component of the computing system, wherein each component included in the one or more components is one of a virtual machine, an application, a service, or a node.

9. The one or more non-transitory computer-readable media of any of clauses 1-8, wherein the reinforcement learning model is associated with performance tuning for a plurality of microservices that are deployed on a computing system, wherein each state included in a plurality of states associated with the reinforcement learning model corresponds to a different set of request rates and latencies associated with the plurality of microservices, and wherein each action included in the plurality of actions corresponds to a different create, read, updated, and delete operation on one or more different microservices included in the plurality of microservices.

10. The one or more non-transitory computer-readable media of any of clauses 1-9, wherein the reinforcement learning model is associated with minimizing pairwise latency for a service mesh of a computing system, wherein each state included in a plurality of states associated with the reinforcement learning model corresponds to a different amount of network traffic within the computing system, and wherein each action included in the plurality of actions corresponds to a different network traffic management action associated with the computing system.

11. In some embodiments, a computer-implemented method comprises receiving a plurality of actions associated with a reinforcement learning model; generating a plurality of combinations of actions based on the plurality of actions; analyzing the plurality of combinations of actions; generating at least one subset of indispensable actions based on the analyzing; selecting a set of training actions from the plurality of actions based on the at least one subset of indispensable actions; and training the reinforcement learning model based on the set of training actions.

12. The computer-implemented method of clause 11, wherein selecting the set of training actions is further based on one or more cumulative rewards associated with the plurality of combinations of actions.

13. The computer-implemented method of clause 11 or clause 12, wherein analyzing the plurality of combinations of actions comprises causing the reinforcement learning model to execute a first number of iterations using a first combination of actions to determine whether the reinforcement learning model satisfies a first threshold condition after the first number of iterations using the first combination of actions.

14. The computer-implemented method of any of clauses 11-13, wherein generating the at least one subset of indispensable actions is based on determining that the reinforcement learning model does not satisfy the first threshold condition after the first number of iterations using the first combination of actions.

15. The computer-implemented method of any of clauses 11-14, wherein generating the at least one subset of indispensable actions comprises generating a first subset of indispensable actions based on analyzing a first combination of actions that does not include the first subset of indispensable actions.

16. The computer-implemented method of any of clauses 11-15, wherein analyzing the plurality of combinations of actions comprises computing a cut-off cardinality associated with the plurality of combinations of actions.

17. The computer-implemented method of any of clauses 11-16, wherein computing the cut-off cardinality comprises evaluating combinations of actions having a given cardinality to determine whether each of the combinations of actions having the given cardinality fail to allow the reinforcement learning model to satisfy a second threshold condition within a second number of iterations.

18. The computer-implemented method of any of clauses 11-17, wherein computing the cut-off cardinality comprises evaluating combinations of actions having a given cardinality to determine whether each of the combinations of actions having the given cardinality fail to improve a cumulative reward by a threshold amount.

19. The computer-implemented method of any of clauses 11-18, wherein analyzing the plurality of combinations of actions comprises evaluating one or more combinations of actions having a cardinality higher than or equal to the cut-off cardinality and not evaluating one or more combinations of actions having a cardinality lower than the cut-off cardinality.

20. The computer-implemented method of any of clauses 11-19, wherein the reinforcement learning model is associated with managing a computing system, wherein each state included in a plurality of states associated with the reinforcement learning model corresponds to a different state of the computing system, and wherein each action included in the plurality of actions corresponds to one of: deploying a virtual machine within the computing system, scaling a node pool included in the computing system, deploying a node, deploying an application, removing an application, performing an create, read, update, and delete operation on a microservice associated with the computing system, scaling a microservice associated with the computing system, or scaling network traffic within the computing system.

21. In some embodiments, a system comprises a memory that stores instructions, and one or more processors that are coupled to the memory and, when executing the instructions, is configured to receive a plurality of actions associated with a reinforcement learning model; generate a plurality of combinations of actions based on the plurality of actions; analyze the plurality of combinations of actions; generate at least one subset of indispensable actions based on the analyzing; select a set of training actions from the plurality of actions based on the at least one subset of indispensable actions; and train the reinforcement learning model based on the set of training actions.

22. The system of clause 21, wherein selecting the set of training actions is further based on one or more cumulative rewards associated with the plurality of combinations of actions.

23. The system of clause 21 or 22, wherein analyzing the plurality of combinations of actions comprises causing the reinforcement learning model to execute a first number of iterations using a first combination of actions to determine whether the reinforcement learning model satisfies a first threshold condition after the first number of iterations using the first combination of actions.

24. The system of system of any of clauses 21-23, wherein generating the at least one subset of indispensable actions is based on determining that the reinforcement learning model does not satisfy the first threshold condition after the first number of iterations using the first combination of actions.

25. The system of system of any of clauses 21-24, wherein generating the at least one subset of indispensable actions comprises generating a first subset of indispensable actions based on analyzing a first combination of actions that does not include the first subset of indispensable actions.

26. The system of system of any of clauses 21-25, wherein analyzing the plurality of combinations of actions comprises computing a cut-off cardinality associated with the plurality of combinations of actions.

27. The system of system of any of clauses 21-26, wherein computing the cut-off cardinality comprises evaluating combinations of actions having a given cardinality to determine whether each of the combinations of actions having the given cardinality fail to allow the reinforcement learning model to satisfy a second threshold condition within a second number of iterations.

28. The system of system of any of clauses 21-27, wherein computing the cut-off cardinality comprises evaluating combinations of actions having a given cardinality to determine whether each of the combinations of actions having the given cardinality fail to improve a cumulative reward by a threshold amount.

29. The system of system of any of clauses 21-28, wherein analyzing the plurality of combinations of actions comprises evaluating one or more combinations of actions having a cardinality higher than or equal to the cut-off cardinality and not evaluating one or more combinations of actions having a cardinality lower than the cut-off cardinality.

30. The system of system of any of clauses 21-29, wherein the reinforcement learning model is associated with managing a computing system, wherein each state included in a plurality of states associated with the reinforcement learning model corresponds to a different state of the computing system, and wherein each action included in the plurality of actions corresponds to one of: deploying a virtual machine within the computing system, scaling a node pool included in the computing system, deploying a node, deploying an application, removing an application, performing an create, read, update, and delete operation on a microservice associated with the computing system, scaling a microservice associated with the computing system, or scaling network traffic within the computing system.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. One or more non-transitory computer-readable media storing program instructions that, when executed by one or more processors, cause the one or more processors to perform a method comprising:
receiving a plurality of actions associated with a reinforcement learning model;
generating a plurality of combinations of actions based on the plurality of actions;
analyzing the plurality of combinations of actions;
generating at least one subset of indispensable actions based on the analyzing;
selecting a set of training actions from the plurality of actions based on the at least one subset of indispensable actions; and
training the reinforcement learning model based on the set of training actions.

2. The one or more non-transitory computer-readable media of claim 1, wherein selecting the set of training actions is further based on one or more cumulative rewards associated with the plurality of combinations of actions.

3. The one or more non-transitory computer-readable media of claim 1, wherein analyzing the plurality of combinations of actions comprises causing the reinforcement learning model to execute a first number of iterations using a first combination of actions to determine whether the reinforcement learning model satisfies a first threshold condition after the first number of iterations using the first combination of actions.

4. The one or more non-transitory computer-readable media of claim 3, wherein generating the at least one subset of indispensable actions is based on determining that the reinforcement learning model does not satisfy the first threshold condition after the first number of iterations using the first combination of actions.

5. The one or more non-transitory computer-readable media of claim 1, wherein generating the at least one subset of indispensable actions comprises generating a first subset of indispensable actions based on analyzing a first combination of actions that does not include the first subset of indispensable actions.

6. The one or more non-transitory computer-readable media of claim 1, wherein analyzing the plurality of combinations of actions comprises computing a cut-off cardinality associated with the plurality of combinations of actions.

7. The one or more non-transitory computer-readable media of claim 6, wherein computing the cut-off cardinality comprises evaluating combinations of actions having a given cardinality to determine whether each of the combinations of actions having the given cardinality fail to improve a cumulative reward by a threshold amount.

8. The one or more non-transitory computer-readable media of claim 1, wherein the reinforcement learning model is associated with managing one or more components of a computing system, wherein each state included in a plurality of states associated with the reinforcement learning model corresponds to a different set of resource utilization metrics associated with the computing system, and wherein each action included in the plurality of actions corresponds to a different component management action associated with a different component of the computing system, wherein each component included in the one or more components is one of a virtual machine, an application, a service, or a node.

9. The one or more non-transitory computer-readable media of claim 1, wherein the reinforcement learning model is associated with performance tuning for a plurality of microservices that are deployed on a computing system, wherein each state included in a plurality of states associated with the reinforcement learning model corresponds to a different set of request rates and latencies associated with the plurality of microservices, and wherein each action included in the plurality of actions corresponds to a different create, read, updated, and delete operation on one or more different microservices included in the plurality of microservices.

10. The one or more non-transitory computer-readable media of claim 1, wherein the reinforcement learning model is associated with minimizing pairwise latency for a service mesh of a computing system, wherein each state included in a plurality of states associated with the reinforcement learning model corresponds to a different amount of network traffic within the computing system, and wherein each action included in the plurality of actions corresponds to a different network traffic management action associated with the computing system.

11. A computer-implemented method comprising:
receiving a plurality of actions associated with a reinforcement learning model;
generating a plurality of combinations of actions based on the plurality of actions;
analyzing the plurality of combinations of actions;
generating at least one subset of indispensable actions based on the analyzing;
selecting a set of training actions from the plurality of actions based on the at least one subset of indispensable actions; and
training the reinforcement learning model based on the set of training actions.

12. The computer-implemented method of claim 11, wherein selecting the set of training actions is further based on one or more cumulative rewards associated with the plurality of combinations of actions.

13. The computer-implemented method of claim 11, wherein analyzing the plurality of combinations of actions comprises causing the reinforcement learning model to execute a first number of iterations using a first combination of actions to determine whether the reinforcement learning model satisfies a first threshold condition after the first number of iterations using the first combination of actions.

14. The computer-implemented method of claim 13, wherein generating the at least one subset of indispensable actions is based on determining that the reinforcement learning model does not satisfy the first threshold condition after the first number of iterations using the first combination of actions.

15. The computer-implemented method of claim 11, wherein generating the at least one subset of indispensable actions comprises generating a first subset of indispensable actions based on analyzing a first combination of actions that does not include the first subset of indispensable actions.

16. The computer-implemented method of claim 11, wherein analyzing the plurality of combinations of actions comprises computing a cut-off cardinality associated with the plurality of combinations of actions.

17. The computer-implemented method of claim 16, wherein computing the cut-off cardinality comprises evaluating combinations of actions having a given cardinality to determine whether each of the combinations of actions having the given cardinality fail to allow the reinforcement learning model to satisfy a second threshold condition within a second number of iterations.

18. The computer-implemented method of claim 16, wherein computing the cut-off cardinality comprises evaluating combinations of actions having a given cardinality to determine whether each of the combinations of actions having the given cardinality fail to improve a cumulative reward by a threshold amount.

19. The computer-implemented method of claim 16, wherein analyzing the plurality of combinations of actions comprises evaluating one or more combinations of actions having a cardinality higher than or equal to the cut-off cardinality and not evaluating one or more combinations of actions having a cardinality lower than the cut-off cardinality.

20. The computer-implemented method of claim 11, wherein the reinforcement learning model is associated with managing a computing system, wherein each state included in a plurality of states associated with the reinforcement learning model corresponds to a different state of the computing system, and wherein each action included in the plurality of actions corresponds to one of: deploying a virtual machine within the computing system, scaling a node pool included in the computing system, deploying a node, deploying an application, removing an application, performing an create, read, update, and delete operation on a microservice associated with the computing system, scaling a microservice associated with the computing system, or scaling network traffic within the computing system.

21. A system comprising:
a memory that stores instructions, and
one or more processors that are coupled to the memory and, when executing the instructions, is configured to:
receive a plurality of actions associated with a reinforcement learning model;
generate a plurality of combinations of actions based on the plurality of actions;
analyze the plurality of combinations of actions;
generate at least one subset of indispensable actions based on the analyzing;
select a set of training actions from the plurality of actions based on the at least one subset of indispensable actions; and
train the reinforcement learning model based on the set of training actions.

22. The system of claim 21, wherein selecting the set of training actions is further based on one or more cumulative rewards associated with the plurality of combinations of actions.

23. The system of claim 21, wherein analyzing the plurality of combinations of actions comprises causing the reinforcement learning model to execute a first number of iterations using a first combination of actions to determine whether the reinforcement learning model satisfies a first threshold condition after the first number of iterations using the first combination of actions.

24. The system of claim 23, wherein generating the at least one subset of indispensable actions is based on determining that the reinforcement learning model does not satisfy the first threshold condition after the first number of iterations using the first combination of actions.

25. The system of claim 21, wherein generating the at least one subset of indispensable actions comprises generating a first subset of indispensable actions based on analyzing a first combination of actions that does not include the first subset of indispensable actions.

26. The system of claim 21, wherein analyzing the plurality of combinations of actions comprises computing a cut-off cardinality associated with the plurality of combinations of actions.

27. The system of claim 26, wherein computing the cut-off cardinality comprises evaluating combinations of actions having a given cardinality to determine whether each of the combinations of actions having the given cardinality fail to allow the reinforcement learning model to satisfy a second threshold condition within a second number of iterations.

28. The system of claim 26, wherein computing the cut-off cardinality comprises evaluating combinations of actions having a given cardinality to determine whether each of the combinations of actions having the given cardinality fail to improve a cumulative reward by a threshold amount.

29. The system of claim 26, wherein analyzing the plurality of combinations of actions comprises evaluating one or more combinations of actions having a cardinality higher than or equal to the cut-off cardinality and not evaluating one or more combinations of actions having a cardinality lower than the cut-off cardinality.

30. The system of claim 21, wherein the reinforcement learning model is associated with managing a computing system, wherein each state included in a plurality of states associated with the reinforcement learning model corresponds to a different state of the computing system, and wherein each action included in the plurality of actions corresponds to one of: deploying a virtual machine within the computing system, scaling a node pool included in the computing system, deploying a node, deploying an application, removing an application, performing an create, read, update, and delete operation on a microservice associated with the computing system, scaling a microservice associated with the computing system, or scaling network traffic within the computing system.
